(19) United States
(12) Patent Application Publication
(10) Pub. No.: US 2004/0257383 A1
(43) Pub. Date: Dec. 23, 2004

(54) Image processing apparatus and method, and imaging apparatus

(75) Inventor: Dai Sato, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/823,677

(22) Filed: Apr. 14, 2004

(30) Foreign Application Priority Data
May 15, 2003 (JP) 2003-137468

(51) Int. Cl. G06K 9/32

(52) U.S. Cl. 345/629

(57) ABSTRACT

The invention aims to easily synthesize a plurality of image information data by using more various and complicated methods, with the circuit size and the manufacturing costs remaining reduced. A control unit supplies different synthesizing image information data to the first and second plane memories and supplies a superposition control information data to a superposing order control unit. Based on the address information data supplied from the address generation counter, the superposing order control unit refers to the held superposition control information data and controls operation of switch circuits. Based on the control, the first switch circuit reads and outputs the synthesis image information data from the first or second plane memory. The second switch circuit outputs an input image signal or the output from the switch circuit to the outside of the image synthesizing apparatus. The present invention is applicable to a camcorder.

### CROSS REFERENCE TO RELATED APPLICATION

This application claims priority from Japanese Priority Document No. 2003-137468, filed on May 15, 2003 with the Japanese Patent Office, which document is hereby incorporated by reference.

### BACKGROUND OF THE INVENTION

1. Field of the Invention

The present invention relates to an image processing apparatus and method, and an imaging apparatus, in particular to an image processing apparatus and method, and an imaging apparatus which easily synthesize a plurality of image information data by using more various and complicated methods with a circuit size and manufacturing costs remaining reduced.

2. Description of the Related Art

Conventionally, a variety of methods have been proposed as an image processing method in which an image signal acquired by taking image via a video camera etc., is superimposed with other image data such as characters and graphics.

For example, several methods have been proposed in which two OSD-ICs (On Screen Display-Integrated Circuit) connected in series respectively superimpose display data on inputted image signals, and a microcomputer controls operation of these two OSD-ICs so as to instantly switch the display data to be superimposed on the image signals, and a plurality of display data are simultaneously displayed on the image signal (see Japanese Laid Open Patent No. H10-150609, pp. 3-6, and FIG. 1, for example).

In addition, another method has been proposed in which an image signal to be superimposed and a superimposing image signal are respectively multiplied by a predetermined coefficient, then these two signals are added together, to thereby specify a synthesizing ratio of two signals arbitrarily.

In these years, as a performance of an image processing apparatus and an image processing technique have been improved, there is increasingly a need for sophisticatedly superimposing image information data, such as various characters and graphics, on an image signal by adopting various methods.

However, a problem in such a method as mentioned above is that the image signal can be superimposed only by a comparatively simple method. For example, in the case of a method of using two OSD-ICs connected in series, a synthesizing ratio of the image signal to be superimposed to the superimposing display data is always one-to-one and therefore the synthesizing ratio cannot be adjusted.

When the method of multiplying the coefficient with each signal is used, a control unit for controlling superimposition of display data can adjust the synthesizing ratio of two signals. However, for example, even when it is desired to change a part of the display data, an OSD-IC must control to prepare and display a new superimposing display data for one screen. Thus, there is a problem in that a processing load in the OSD-IC increases and its manufacturing costs may also increase. In addition, there is another problem with this method that since a rewrite timing of the superimposing display data is limited to, for example, a vertical blanking period, a horizontal blanking period, etc., it is necessary for the OSD-IC to carry out the process at a high speed, thus increasing the manufacturing costs further.

Further, even in the case where the method of using a plurality of OSD-ICs connected in series is combined with the method of multiplying the coefficient, it is impossible to control the superimposing display data for each partial area of the screen. Therefore, there is another problem that, when switching the display data, a display data for one screen must be prepared to thereby increases the processing load and the circuit size.

For example, when the display data are superimposed on two mutually different areas, such as a first area and a second area of an image data for one screen corresponding to the image signal, if the display data only in the first area is switched, it is necessary to prepare three OSD-ICs, which are a first OSD-IC for superimposing the display data displayed on the first area before the switching, a second OSD-IC for superimposing the display data displayed on the second area, and a third OSD-IC for superimposing the display data displayed on the first area after the switching. Therefore, in this method, in order to carry out a complicated method of switching the superimposing display data, it is necessary to prepare a lot of OSD-ICs beforehand so as correspond to the degree of complexity, so that not only the load of processing increases but also the circuit size becomes larger, which leads to increased manufacturing costs.

### SUMMARY OF THE INVENTION

In view of the above situation, the present invention has been invented to easily synthesize a plurality of image information data using various and complicated method, with the reduced circuit size and manufacturing costs.

An image processing apparatus according to the present invention includes: synthesizing image information data holding means for holding a plurality of image information data to be synthesized; synthesis control means for controlling synthesis of the plurality of synthesizing image information data held in the synthesizing image information data holding means and input image information data, for every arbitrary area of an input image corresponding to the input image information data; and image information data synthesis means for synthesizing the input image information data and the synthesizing image information data according to the control by means of the synthesis control means.

The synthesizing image holding means can hold the synthesizing image information data as data on a pixel-by-pixel basis. The synthesizing image holding means can hold information data obtained by arranging the synthesizing image information data in a table.

The synthesis control means includes control information data holding means for holding control information data about control of synthesis of the synthesizing image information data and the input image information data, so as to control the synthesis of the synthesizing image information data and the input image information data according to the control information data held in the control information data holding means.

The control information data is an information data for specifying, in an arbitrary area, synthesizing image information data corresponding to a synthesizing image to be superimposed on the input image by selecting it from the plurality of synthesizing image information data held in the synthesizing image information data holding means. Based on the control information data, the synthesis control means determines whether or not each of the plurality of synthesizing image information data held in the synthesizing image information data holding means is synthesized with the input image information data, such that the synthesizing image information data which is determined to be synthesized is controlled to be synthesized with the input image information data. Based on the control by means of the synthesis control means, the image information data synthesis means synthesizes the input image information data and the synthesizing image information data so as to superimpose the input image on the synthesizing image and vice versa in an arbitrary area.

The control information data is an information data for specifying a synthesizing ratio of respective image information data in arbitrary areas when mixing the input image with the synthesizing image corresponding to the plurality of synthesizing image information data held in the synthesizing image information data holding means. Based on the control information data, the synthesis. control means controls the plurality of synthesizing image information data held at the synthesizing image information data holding means so as to be synthesized with the input image information data at the specified synthesizing ratio. Based on the control by means of the synthesis control means, the image information data synthesis means synthesizes the input image information data and the synthesizing image information data so as to mix the input image and the synthesizing image at the specified synthesizing ratio in the arbitrary areas.

The synthesis control means further includes, in the arbitrary areas, graphics determination means for determining whether or not graphics exist in the synthesizing image corresponding to the synthesizing image information data synthesized with the input image information data. When it is determined that there are not graphics by way of the determination by means of the graphics determination means, it is possible to control the synthesizing image information data so as not to be synthesized with the input image information data.

An amount of data of the control information data can be smaller than an amount of data of the synthesizing image information data held in the synthesizing image information data holding means. The control information data can be an information data on a pixel-by-pixel basis. The control information data can be an information data obtained by arranging, in a table, transition points where control changes.

Further the image processing apparatus further includes address information data generation means for generating the address information data which indicates a location in a screen for the input image, and based on the address information data generated by the address information data generation means, the synthesis control means can control the synthesis of the input image information data and the plurality of synthesizing image information data held in the synthesizing image information data holding means such that synthesis locations of the synthesizing image information data and input image information data may be positioned properly.

Further the image processing apparatus includes synchronizing signal separation means for separating a synchronizing signal added to the input image information data, the address information data generation means can generate address information data, based on the synchronizing signal separated from input image information data by the synchronizing signal separation means.

The image processing method of the present invention includes: an synthesizing image information data hold control step of controlling hold of a plurality of synthesizing image information data; a synthesis control step of controlling synthesis of the input image information data and the plurality of synthesizing image information data which are controlled and held by way of a process of the synthesizing image information data hold control step, for every arbitrary area of an input image corresponding to an input image information data; and an image information data synthesis step of synthesizing the input image information data and the synthesizing image information data, according to the control by way of the process of the synthesis control step.

The synthesizing image hold control step can control and hold the synthesizing image information data as data on a pixel-by-pixel basis. The synthesizing image hold control step can control and hold information data obtained by arranging the synthesizing image information data in a table.

The synthesis control step includes a control information data hold control step of controlling hold of the control information data about control of synthesis of the synthesizing image information data and the input image information data, so as to control the synthesis of the synthesizing image information data and input image information data according to the control information data which is controlled and held by way of the process of the control information data hold control step.

In the arbitrary areas, according to the control information data for specifying the synthesizing image information data corresponding to the synthesizing image which is superimposed on the input image, by selecting it from the plurality of synthesizing image information data which are controlled and held by way of the process of the synthesizing image information data hold control step, the synthesis control step determines whether each of the plurality of synthesizing image information data which are controlled and held by way of the process of the synthesizing image information data hold control step is synthesized with the input image information data or not. The synthesizing image information data which is determined to be synthesized is controlled so as to be synthesized with the input image information data. Based on the control by way of the process of the synthesis control step, the image information data synthesis step synthesizes the input image information data and the synthesizing image information data so as to superimpose the input image on the synthesizing image and vice versa in the arbitrary areas.

In the arbitrary areas, the synthesis control step controls the plurality of synthesizing image information data which are controlled and held by way of the process of the synthesizing image information data hold control step so as to be synthesized with the input image information data at the specified synthesizing ratio, according to the control information data for specifying the synthesizing ratio of each image information data when mixing, with the input image, the synthesizing image corresponding to the plurality of synthesizing image information data which are controlled and held by way of the process of the synthesizing image information data hold control step. Based on the control by way of the process of the synthesis control step, the image information data synthesis step synthesizes the input image information data and the synthesizing image information data so as to mix the input image and the synthesizing image at the specified synthesizing ratio in the arbitrary areas.

The process of the synthesis control step further includes a graphics determination step of determining whether or not graphics exist in the synthesizing image corresponding to the synthesizing image information data which is synthesized with the input image information data in the arbitrary areas. When it is determined that there are not graphics through the determination by way of the process of the graphics determination step, it is possible to control the synthesizing image information data so as not to be synthesized with the input image information data.

The amount of data of the control information data can be smaller than the amount of data of the synthesizing image information data which is controlled and held by way of the process of the synthesizing image information data hold control step. The control information data can be an information data on a pixel-by-pixel basis. The control information data can be an information data obtained by arranging, in a table, the transition points where the control changes.

Further the method includes an address information data generation step of generating the address information data which indicates a location in a screen for the input image, and based on the address information data generated by way of the process of the address information data generation step, the synthesis control step can control the synthesis of the input image information data and the plurality of synthesizing image information data which are controlled and held by way of the process of the synthesizing image information data hold control step, so that the synthesis locations of the synthesizing image information data and the input image information data may be positioned properly.

Further the method includes a synchronizing signal separation step of separating a synchronizing signal added to the input image information data, the address information data generation step can generate address information data, based on the synchronizing signal separated from input image information data by way of the process of the synchronizing signal separation step.

An imaging apparatus according to the present invention includes: imaging means for imaging a photographic subject and capturing an taken image information data which is an acquired image information data; an synthesizing image information data holding means for holding a plurality of synthesizing image information data which are synthesized with the taken image information data captured by the imaging means; synthesis control means for controlling synthesis of the taken image information data and the plurality of synthesizing image information data which are held in the synthesizing image information data holding means, for every arbitrary area of the taken image corresponding to the taken image information data; and image information data synthesis means for synthesizing the taken image information data and the synthesizing image information data according to control by means of the synthesis control means.

According to the present invention, the plurality of synthesizing image information data are held; the synthesis of the plurality of synthesizing image information data and input image information data is controlled for every arbitrary area of the input image corresponding to input image information data; based on the control, the input image information data and the synthesizing image information data are synthesized.

As described above, according to the present invention, the plurality of image information data can be synthesized. In particular, the plurality of image information data can be easily synthesized by using various and complicated methods, with the circuit size and the manufacturing costs remaining reduced.

### BRIEF DESCRIPTION OF THE DRAWINGS

FIG. 1 is a block diagram showing an example of structure of an image synthesizing apparatus to which the present invention is applied;

FIGS. 2A and 2B are charts showing an example of arrangement of a storage area of a first plane memory of FIG. 1;

FIGS. 3A and 3B are charts showing an example of arrangement of a storage area of a superposing order control unit of FIG. 1;

FIG. 4 is a flow chart for explaining an image synthesis process by means of the image synthesizing apparatus of FIG. 1;

FIG. 5 is another flow chart following the flow chart in FIG. 4, for explaining the image synthesis process by means the image synthesizing apparatus of FIG. 1;

FIGS. 6A to 6C are views showing an example of image which is synthesized by the image synthesizing apparatus of FIG. 1;

FIGS. 7A to 7C are views showing an example of the way in which an image is synthesized by the image synthesizing apparatus of FIG. 1;

FIG. 8 is a block diagram showing another example of structure of the image synthesizing apparatus to which the present invention is applied;

FIGS. 9A and 9B are views showing an example of arrangement of a storage area of a synthesizing ratio control unit in FIG. 8;

FIG. 10 is a flow chart for explaining an image synthesis process by means the image synthesizing apparatus of FIG. 8;

FIG. 11 is a flow chart following that of FIG. 10 for explaining the image synthesis process by means of the image synthesizing apparatus of FIG. 8;

FIGS. 12A to 12C are views showing an example of image which is synthesized by the image synthesizing apparatus of FIG. 8;

FIGS. 13A to 13C are views showing an example of the way in which the image is synthesized by means of the image synthesizing apparatus of FIG. 8;

FIGS. 14A and 14B are views showing an example of the way in which the image is synthesized by means of the image synthesizing apparatus of FIG. 8;

FIG. 15 is a block diagram showing an example of structure of a camcorder to which the present invention is applied; and

FIG. 16 is a block diagram showing an example of structure of a personal computer.

### DETAILED DESCRIPTION OF THE PREFERRED EMBODIMENTS

Hereafter, the preferred embodiments of the present invention will be described, and the followings are relationships between a constituent element recited in a claim and an example of the preferred embodiments in accordance with the present invention. The description is for confirming that an example which supports the invention recited in the claim is recited in the description of the preferred embodiments of the present invention. Therefore, if there is an example which is recited in the preferred embodiments of the invention and not recited herein as one corresponding to constituent element, it does not mean that the example does not correspond to the constituent element. In contrast, if the example is recited as one corresponding to the constituent element, it does not mean that the example does not correspond to any constituent element other than the constituent elements.

Further, this description does not mean that the invention corresponding to the example recited in the preferred embodiments of the invention is recited in all claims. In other words, this description corresponds to the example recited in the description of the preferred embodiments and does not deny existence of the invention which is not recited in a claim of this application, i.e. existence of the invention to be divided into a divisional application or to be added through amendments in the future.

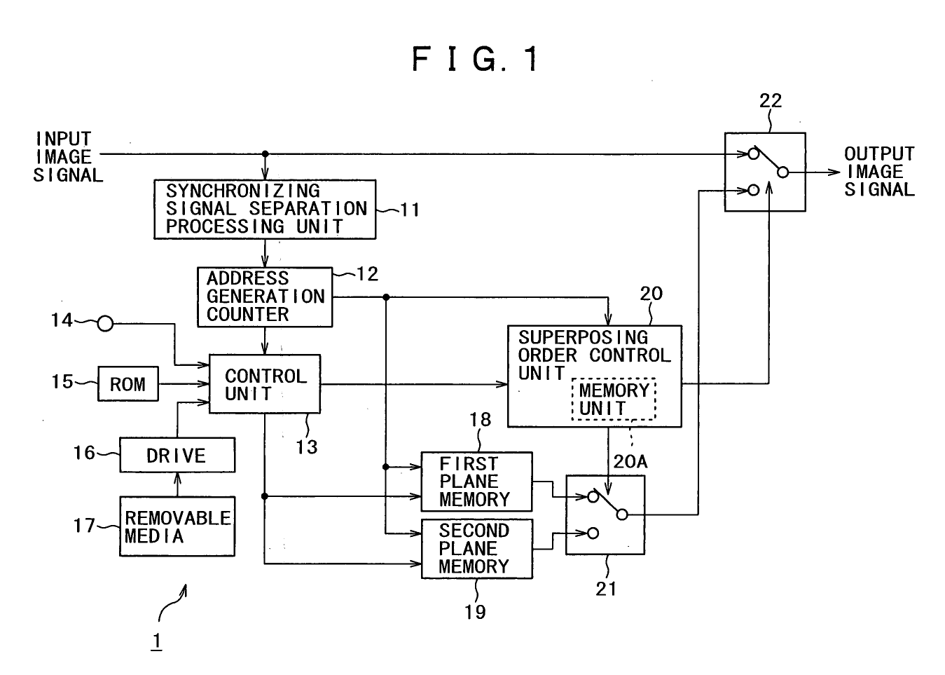

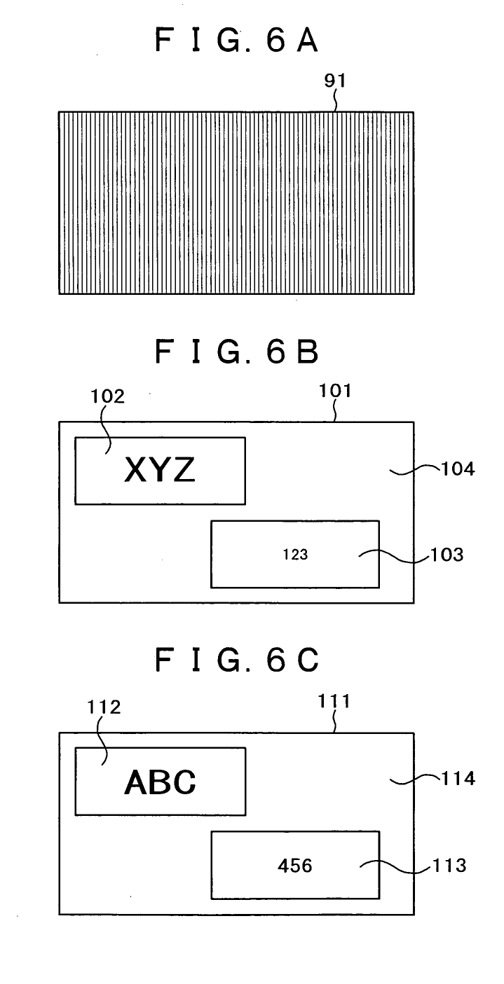

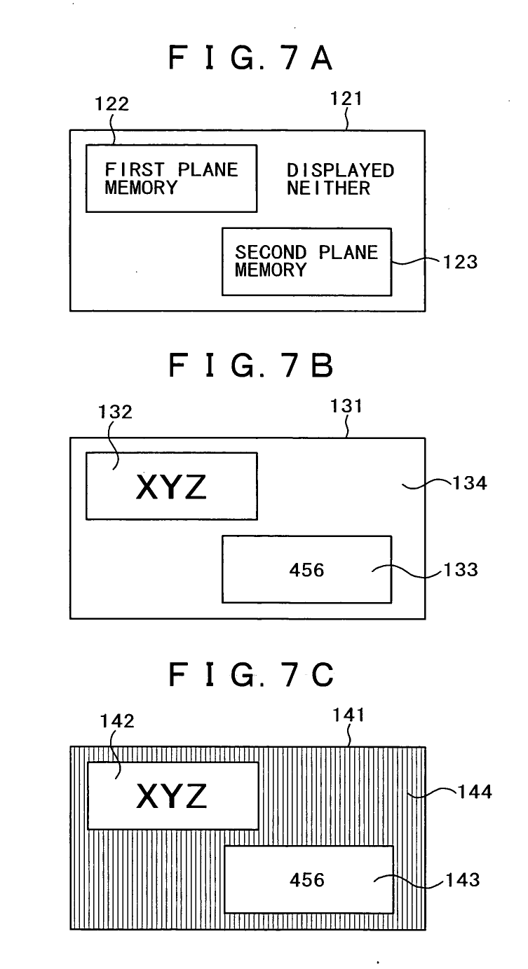

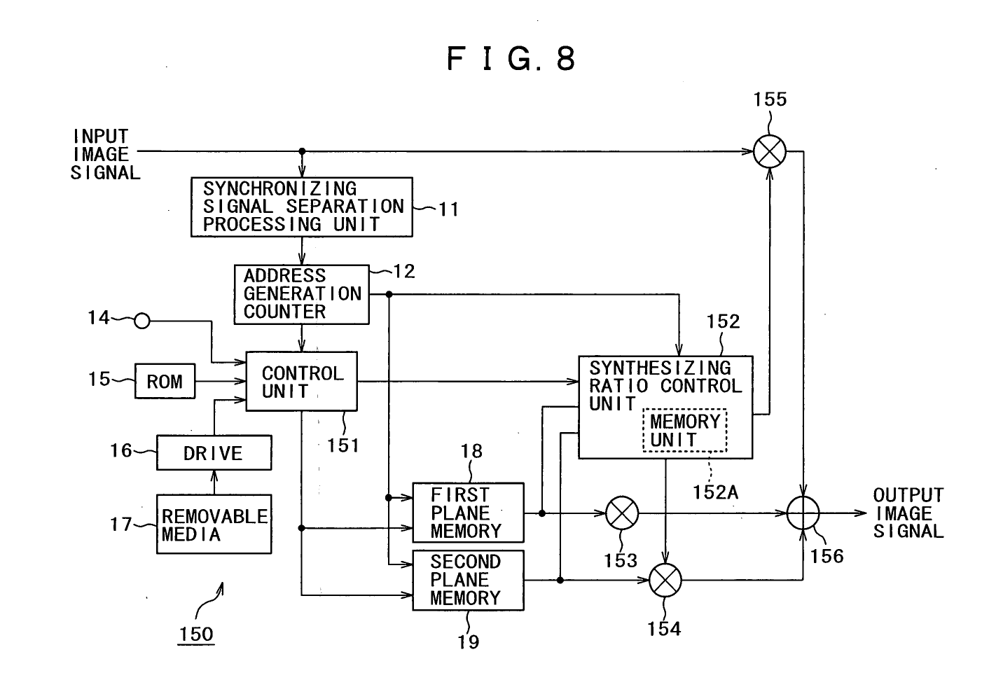

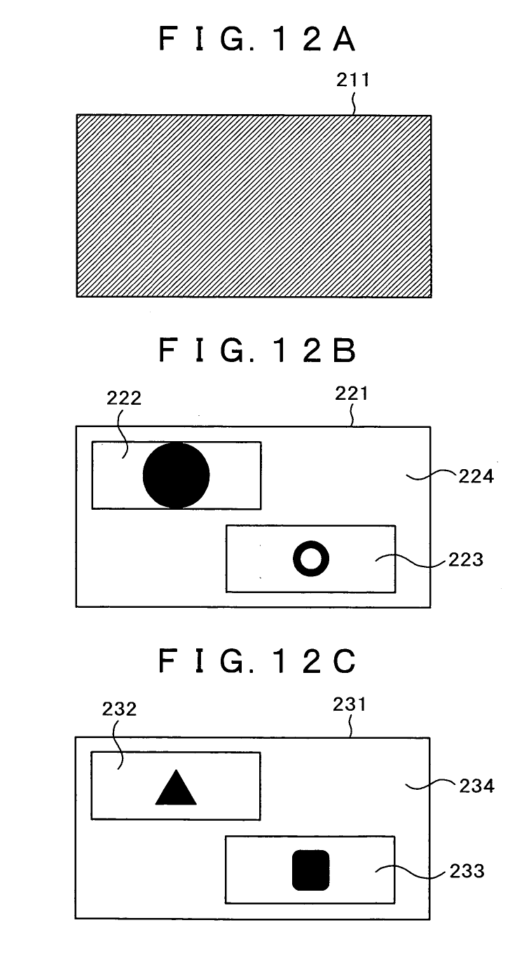

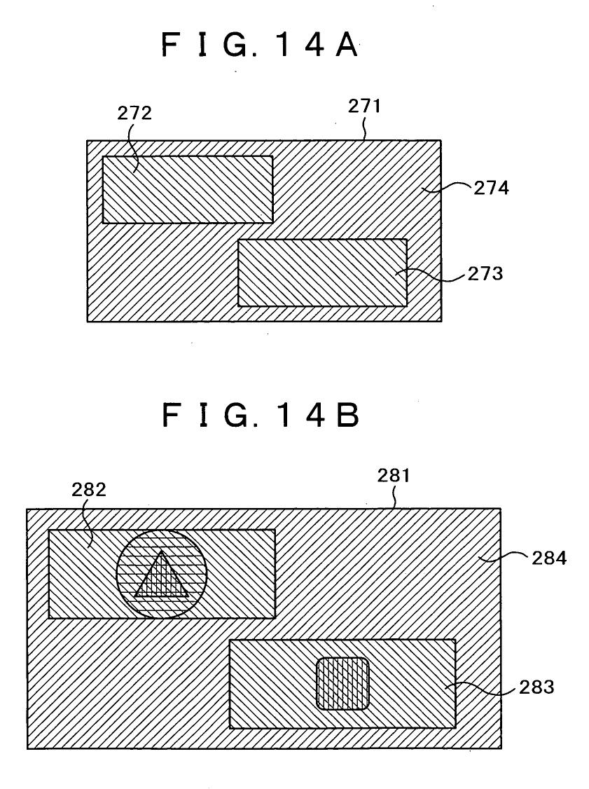

In a first aspect of the present invention, an image processing apparatus (for example, an image synthesizing apparatus 1 of FIG. 1 or an image synthesizing apparatus 150 of FIG. 8) in which an input image information data which is an image information data contained in an input image signal is synthesized with an synthesizing image information data which is an image information data different from the input image information data, the image processing apparatus comprises: synthesizing image information data holding means for holding a plurality of the synthesizing image information data (for example, a first plane memory 18 and a second plane memory 19 of FIG. 1 or 8); synthesis control means (for example, a superposing order control unit 20 of FIG. 1 or a synthesizing ratio control unit 152 of FIG. 8) for controlling synthesis of the input image information data and the plurality of the input synthesizing image information data which are held in the synthesizing image information data holding means, for every arbitrary area (for example, a area 142 through a area 144 of FIG. 7C, or areas 282 through 284 of FIG. 14B) of the input image (for example, an input image 91 of FIG. 6A or an input image 211 of FIG. 12A) corresponding to the input image information data; and image information data synthesis means for synthesizing the input image information data and the synthesizing image information data (for example, switch circuits 21 and 22 of FIG. 1, or multipliers 153 through 155, and an adder 156 of FIG. 8) according. to the control by means of the synthesis control means.

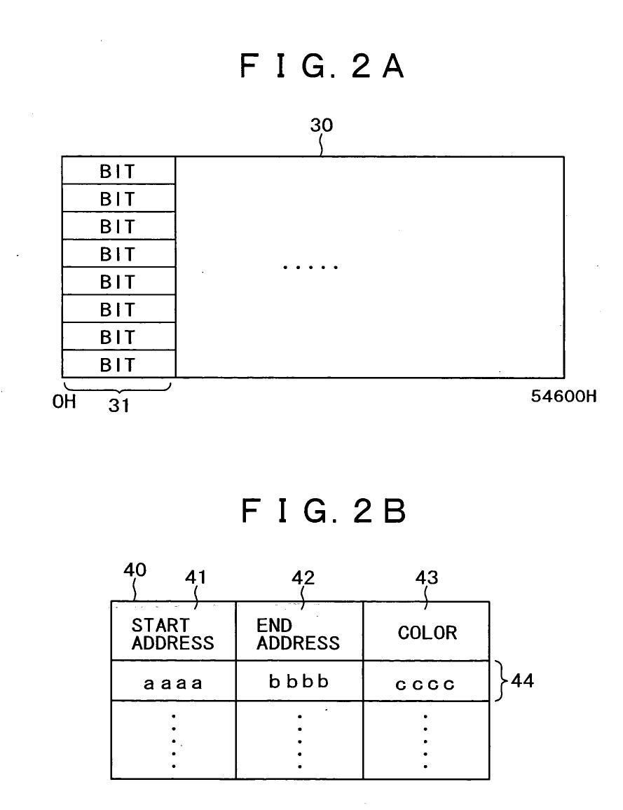

In a second aspect of the invention, the image processing apparatus as recited in the first aspect, the synthesizing image holding means holds the synthesizing image information data as a data on a pixel-by-pixel basis (for example, a data 31 on a pixel-by-pixel basis in FIG. 2A).

In a third aspect of the image processing apparatus as recited in the first aspect, the synthesizing image holding means holds information data obtained by arranging the synthesizing image information data in a table (for example, a table 40 of FIG. 2B).

In a forth aspect of the image processing apparatus as recited in the first aspect, the synthesis control means includes control information data holding means (for example, a memory unit 20A of FIG. 1 or a memory unit 152A of FIG. 8) for holding control information data about control of synthesis of the synthesizing image information data and the input image information data, so as to control the synthesis of the synthesizing image information data and the input image information data according to the control information data held in the control information data holding means.

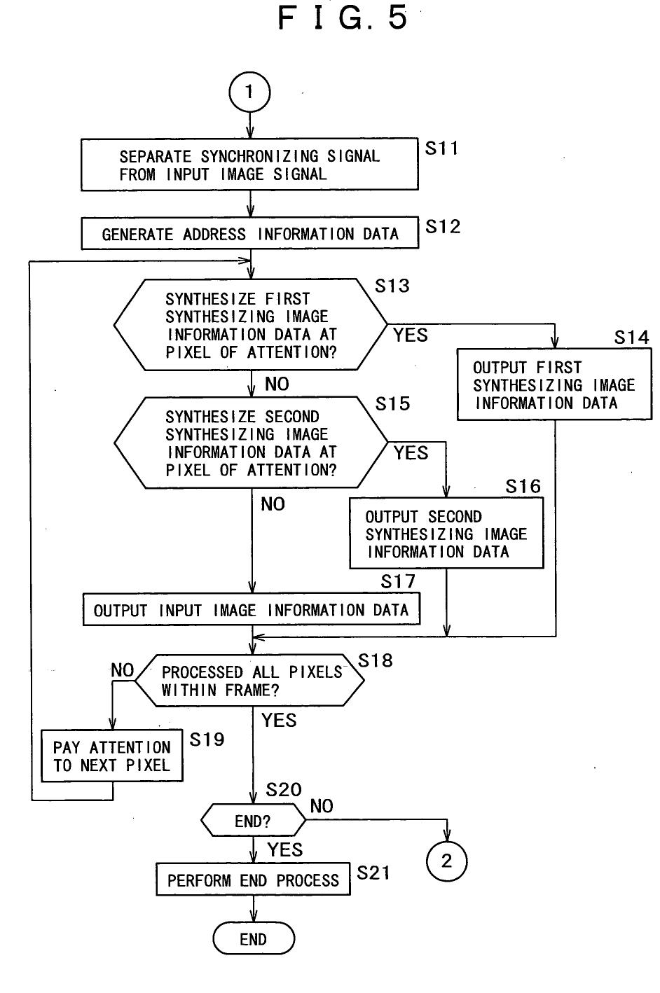

In a fifth aspect of the image processing apparatus as recited in the forth aspect, the control information data is information data (for example, superposition control information data corresponding to an image 121 of FIG. 7A) for specifying, in the arbitrary area, the synthesizing image information data corresponding to a synthesizing image to be superimposed on the input image by selecting it from the plurality of synthesizing image information data held in the synthesizing image information data holding means, based on the control information data, the synthesis control means determines whether or not each of the plurality of synthesizing image information data held in the synthesizing image information data holding means is synthesized with the input image information data (for example, step S13 and step S15 of FIG. 5), such that the synthesizing image information data which has been determined to be synthesized is controlled to be synthesized with the input image information data, and based on the control by means of the synthesis control means, the image information data synthesis means synthesizes the input image information data and the synthesizing image information data so as to superimpose the input image on the synthesizing image and vice versa in the arbitrary area (for example, step S14 and step S16 of FIG. 5).

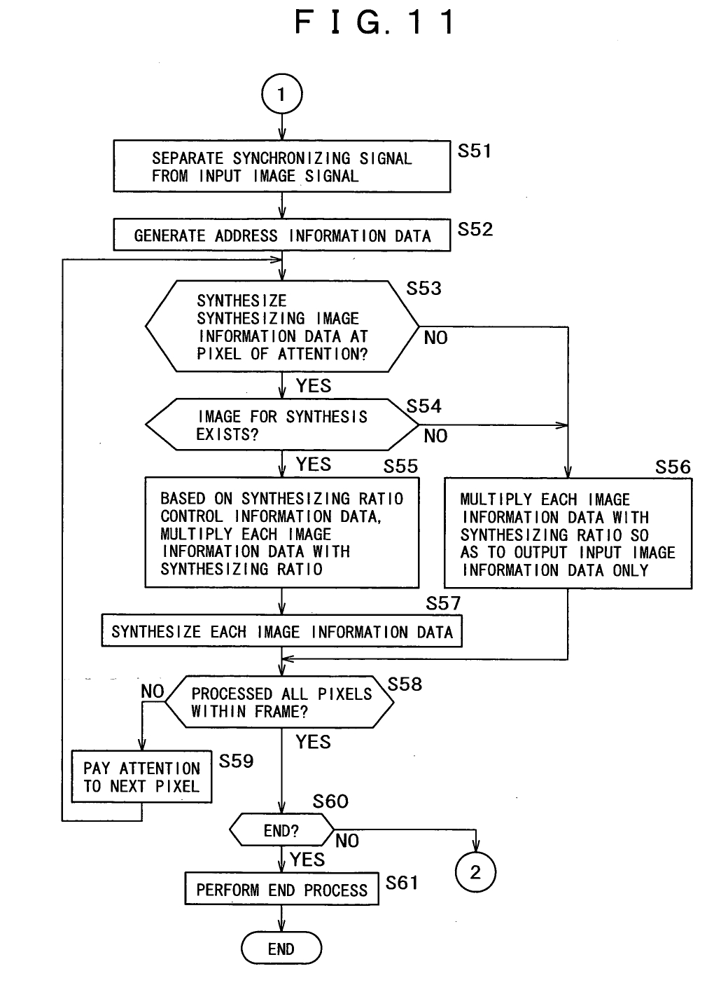

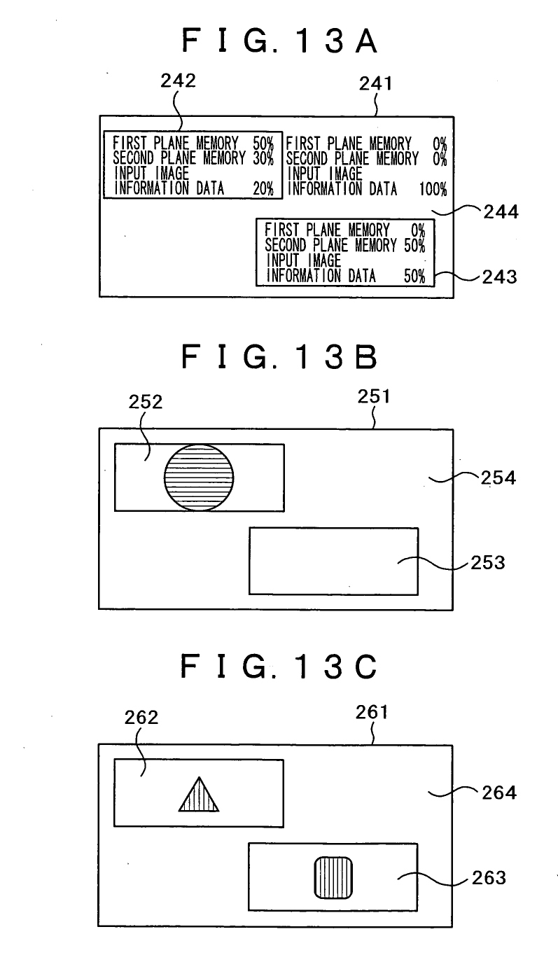

In a sixth aspect of the image processing apparatus as recited in the forth aspect, the control information data is information data (for example, synthesizing ratio control information data corresponding to an image 241 of FIG. 13A) for specifying the synthesizing ratio of each image information data in the arbitrary area, when mixing the input image with the synthesizing image corresponding to the plurality of synthesizing image information data held in the synthesizing image information data holding means, based on the control information data, the synthesis control means controls the plurality of synthesizing image information data held at the synthesizing image information data holding means so as to be synthesized with the input image information data at the specified synthesizing ratio (for example, step S53 of FIG. 11), and based on the control by means of the synthesis control means, the image information data synthesis means synthesizes the input image information data and the synthesizing image information data so as to mix the input image and the synthesizing image at the specified synthesizing ratio in the arbitrary area (for example, step S55 through step S57 of FIG. 11).

In a seventh aspect of the image processing apparatus as recited in the forth aspect, the synthesis control means further includes, in the arbitrary area, graphics determination means (for example, a synthesizing ratio control unit 152 of FIG. 8 for performing a process in step S54 of FIG. 11) for determining whether or not graphics exist in the synthesizing image corresponding to the synthesizing image information data synthesized with the input image information data, and when it is determined that there are not graphics by way of the determination through the graphics determination means, the synthesis control means controls the synthesizing image information data so as not to be synthesized with the input image information data (Step S54 and step S56 of FIG. 11).

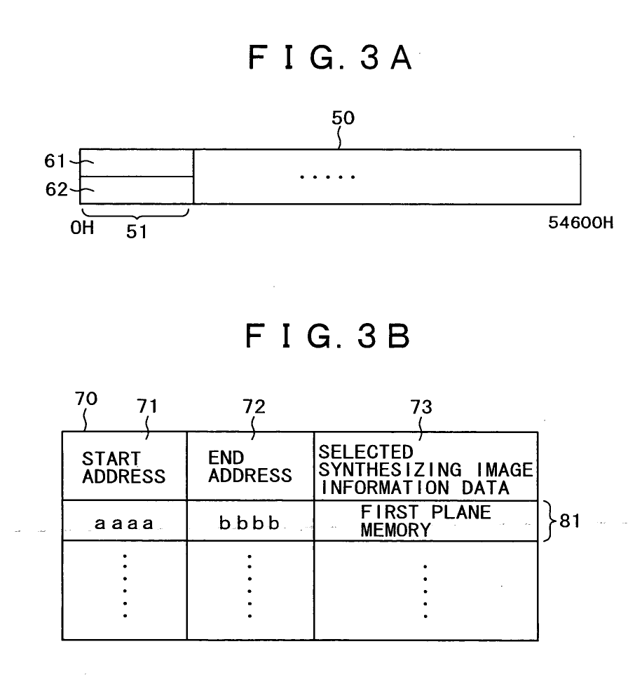

In an eighth aspect of the image processing apparatus as recited in the forth aspect, an amount of data of the control information data is smaller (for example, FIG. 3A) than an amount of data of the synthesizing image information data held in the synthesizing image information data holding means.

In an ninth aspect of the image processing apparatus as recited in the forth aspect, the control information data is an information data on a pixel-by-pixel basis (for example, superposition control information data 51 on a pixel-by-pixel basis in FIG. 3A).

In a tenth aspect of the image processing apparatus as recited in the forth aspect, the control information data is an information data obtained by arranging transition points where control changes, in a table (for example, a table 70 in FIG. 3B).

In an eleventh aspect of the image processing apparatus as recited in the first aspect, the image processing apparatus further includes address information data generation means (for example, an address generation counter 12 of FIG. 1 or FIG. 8) for generating the address information data which indicates a location in a screen for the input image, wherein based on the address information data generated by the address information data generation means, the synthesis control means controls the synthesis of the input image information data and the plurality of synthesizing image information data held in the synthesizing image information data holding means such that synthesis locations of the synthesizing image information data and the input image information data may be positioned properly.

In a twelfth aspect of the image processing apparatus as recited in the eleventh aspect, the image processing apparatus further includes synchronizing signal separation means (for example, a synchronizing signal separation processing unit 11 of FIG. 1 or FIG. 8) for separating a synchronizing signal added to the input image information data, wherein the address information data generation means generates the address information data, based on the synchronizing signal separated from the input image information data by the synchronizing signal separation means.

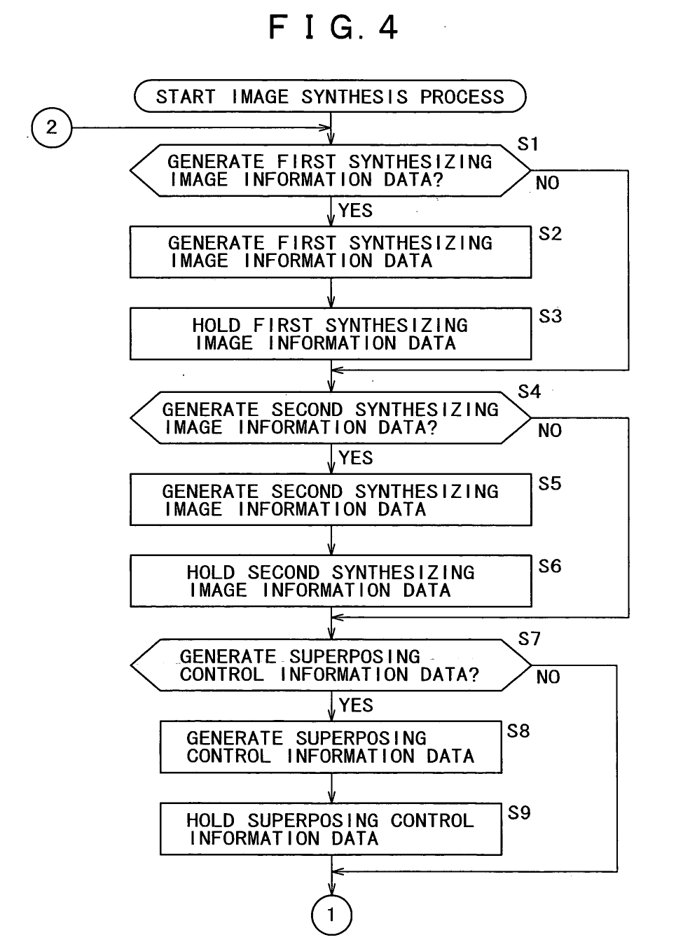

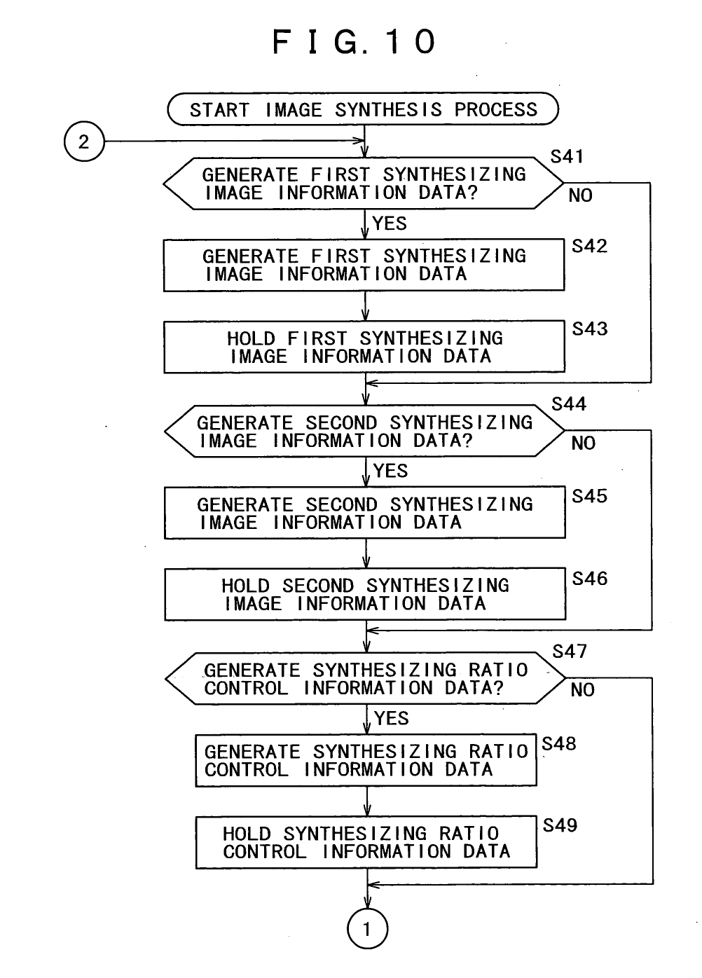

In a thirteenth aspect of the present invention, an image processing method for an image processing apparatus (for example, the image synthesizing apparatus 1 of FIG. 1 or the image synthesizing apparatus 150 of FIG. 8) in which an synthesizing image information data which is an image information data and different from an input image information data is synthesized with the input image information data which is an image information data contained in an input image signal, the image processing method includes: synthesizing image information data hold control step of controlling hold of a plurality of the synthesizing image information data (for example, step S3 and step S6 of FIG. 4, or step S43 and step S46 of FIG. 10); a synthesis control step of controlling synthesis of the input image information data and the plurality of synthesizing image information data which are controlled and held by way of a process of the synthesizing image information data hold control step, for every arbitrary area (for example, the area 142 through area 144 of FIG. 7C, or areas 282 through 284 of FIG. 14B) of an input image (for example, the input image 91 of FIG. 6A or the input image 211 of FIG. 12A) corresponding to the input image information data (for example, step S13 and step S15 of FIG. 5, or step S53 of FIG. 11); and an image information data synthesis step of synthesizing the input image information data and the synthesizing image information data, according to the control by way of the process of the synthesis control step (for example, step S14 and step S16 of FIG. 5, or step S55 through step S57 of FIG. 11).

In a fourteenth aspect of the image processing method as recited in the thirteenth aspect, the synthesizing image hold control step controls and holds the synthesizing image information data as a data on a pixel-by-pixel basis (for example, the data 31 on a pixel-by-pixel basis of FIG. 2A).

In a fifteenth aspect of the image processing method as recited in the thirteenth aspect, the synthesizing image hold control step controls and holds information data obtained by arranging the synthesizing image information data in a table (for example, the table 40 of FIG. 2B).

In a sixteenth aspect of the image processing method as recited in the thirteenth aspect, the synthesis control step includes a control information data hold control step of controlling hold of the control information data about the control of the synthesis of the synthesizing image information data and the input image information data (for example, step S9 of FIG. 4 or step S49 of FIG. 10), and based on the control information data which is controlled and held by way of the process of the control information data hold control step, the synthesis control step controls the synthesis of the synthesizing image information data and the input image information data.

In a seventeenth aspect of the image processing method as recited in the sixteenth aspect, the synthesis control step determines, in the arbitrary area, whether each of the plurality of synthesizing image information data which are controlled and held by way of the process of the synthesizing image information data hold control step is synthesized with the input image information data or not (for example, step S13 and step S15 of FIG. 5), according to the control information data (for example, the superposition control information data corresponding to the image 121 of FIG. 7A) for specifying the synthesizing image information data corresponding to the synthesizing image which is superimposed on the input image, by selecting it from the plurality of synthesizing image information data which are controlled and held by way of the process of the synthesizing image information data hold control step, the synthesizing image information data which has been determined to be synthesized is controlled so as to be synthesized with the input image information data, and based on the control by way of the process of the synthesis control step, the image information data synthesis step synthesizes the input image information data and the synthesizing image information data so as to superimpose the input image on the synthesizing image and vice versa in the arbitrary area (for example, step S14 and step S16 of FIG. 5).

In an eighteenth aspect of the image processing method as recited in the sixteenth aspect, the synthesis control step controls, in the arbitrary area, the plurality of synthesizing image information data which are controlled and held by way of the process of the synthesizing image information data hold control step so as to be synthesized with the input image information data at the specified synthesizing ratio (for example, step S53 of FIG. 11), according to the control information data (for example, the synthesizing ratio control information data corresponding to the image 241 of FIG. 13A) for specifying the synthesizing ratio of each image information data when mixing, with the input image, the synthesizing image corresponding to the plurality of synthesizing image information data which are controlled and held by way of the process of the synthesizing image information data hold control step, and based on the control by way of the process of the synthesis control step, the image information data synthesis step synthesizes the input image information data and the synthesizing image information data so as to mix the input image and the synthesizing image at the specified synthesizing ratio in the arbitrary area (for example, step S55 through step S57 of FIG. 11).

In an nineteenth aspect of the image processing method as recited in the sixteenth aspect, the process of the synthesis control step further includes a graphics determination step (for example, step S54 of FIG. 11) of determining whether or not graphics exist in the synthesizing image corresponding to the synthesizing image information data which is synthesized with the input image information data in the arbitrary area, and when it is determined that there are not the graphics through the determination by way of the process of the graphics determination step, the process of the synthesis control step controls the synthesizing image information data so as not to be synthesized with the input image information data (Step S56 of FIG. 11).

In a twentieth aspect of the image processing method as recited in the sixteenth aspect, the amount of data of the control information data is smaller than the amount of data of the synthesizing image information data which is controlled and held by way of the process of the synthesizing image information data hold control step (for example, FIG. 3A).

In a twenty-first aspect of the image processing method as recited in the sixteenth aspect, the control information data is an information data on a pixel-by-pixel basis (for example, the superposition control information data 51 on a pixel-by-pixel basis in FIG. 3A).

In a twenty-second aspect of the image processing method as recited in the sixteenth aspect, the control information data is an information data obtained by arranging transition points where the control changes, in a table (for example, the table 70 of FIG. 3B).

In a twenty-third aspect of the image processing method as recited in the thirteenth aspect, the image processing method further includes an address information data generation step (for example, step S12 of FIG. 5 or step S52 of FIG. 11) of generating the address information data which indicates a location in a screen for the input image, wherein based on the address information data generated by way of the process of the address information data generation step, the synthesis control step controls the synthesis of the input image information data and the plurality of synthesizing image information data which are controlled and held by way of the process of the synthesizing image information data hold control step, so that the synthesis locations of the synthesizing image information data and the input image information data may be positioned properly.

In a twenty-forth aspect of the image processing method as recited in the twenty-third aspect, the image processing method further includes a synchronizing signal separation step (for example, step S11 of FIG. 5 or step S51 of FIG. 11) of separating a synchronizing signal added to the input image information data, wherein the address information data generation step generates the address information data, based on the synchronizing signal separated from the input image information data by way of the process of the synchronizing signal separation step.

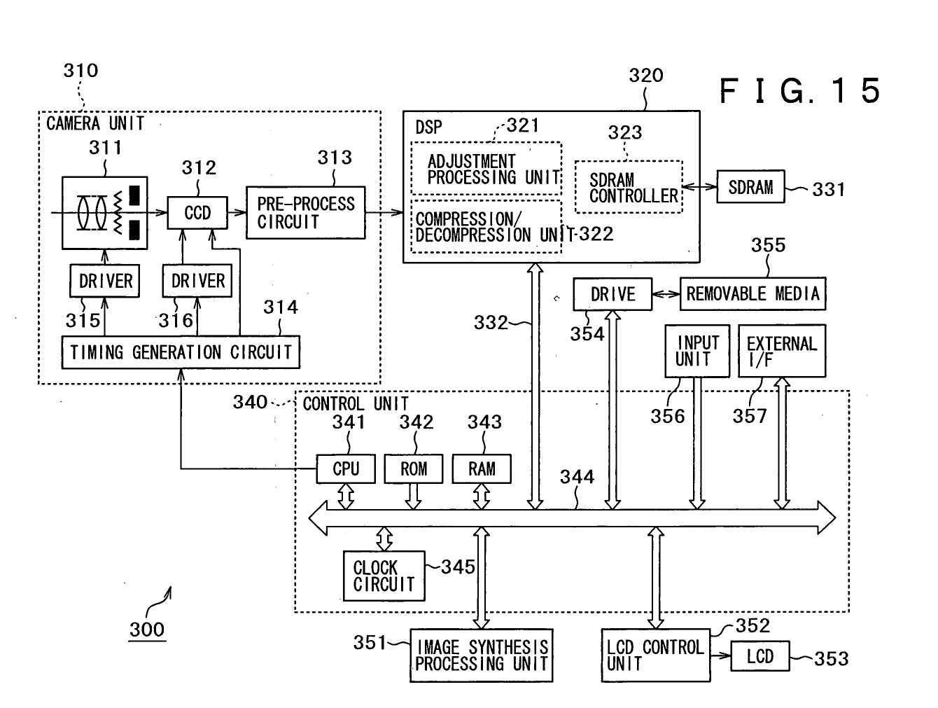

In a twenty-fifth aspect of the present invention, an imaging apparatus (for example, a camcorder 300 of FIG. 15) includes: imaging means (for example, a camera unit 310 of FIG. 15) for imaging a photographic subject and capturing a taken image information data which is an acquired image information data; synthesizing image information data holding means (for example, the first plane memory 18 and the second plane memory 19 of FIG. 1 or FIG. 8) for holding a plurality of synthesizing image information data which are synthesized with the taken image information data captured by the imaging means; synthesis control means (for example, the superposing order control unit 20 of FIG. 1 or the synthesizing ratio control unit 152 of FIG. 8) for controlling synthesis of the taken image information data and the plurality of synthesizing image information data which are held in the synthesizing image information data holding means, for every arbitrary area of the taken image corresponding to the taken image information data; and image information data synthesis means (for example, the switch circuits 21 and 22 of FIG. 1, or the multipliers 153 through 155 and the adder 156 of FIG. 8) for synthesizing the taken image information data and the synthesizing image information data according to control by means of the synthesis control means.

Hereafter, the preferred embodiments according to the present invention will be described with reference to the accompanying drawings. FIG. 1 is a block diagram showing an example of structure of an image synthesizing apparatus to which the present invention is applied.

In FIG. 1, an image synthesizing apparatus 1 is an apparatus in which, into a part or the whole of an image corresponding to an input image signal, such as an image signal included in a television signal corresponding to an NTSC (National Television Standards Committee) standard or the PAL (PhaseAlternationbyLine) standard, for example, another image showing a character, graphics, etc. is inserted, so that the resulting image is outputted as an output image signal. In other words, in the image synthesizing apparatus 1, the synthesizing image information data which are other image information data are selectively synthesized with an input image information data contained in the input image signal, so as to be outputted. At this stage, the image synthesizing apparatus 1 can synthesize the image information data such that, in a plurality of areas in the screen of the image corresponding to the input image signal, the character, the graphics, etc. may be synthesized independently of one another for each area. For example, the image synthesizing apparatus 1 can change a part of another image inserted into the image corresponding to the input image signal, and further switch the image to still another image, or move it to another position.

Although not shown, the synchronizing signal separation processing unit 11 of the image synthesizing apparatus 1 includes an amplitude separation processing unit and a frequency separation processing unit, extracts a vertical synchronizing signal and a horizontal synchronizing signal from an input image signal, and supplies the synchronizing signals to an address generation counter 12. For example, when the input image signal is an image signal corresponding to the NTSC standard, the input image signal includes a vertical synchronizing signal whose frequency is approximately 60 Hz and a horizontal synchronizing signal whose frequency is approximately 15.75 kHz. Firstly, the synchronizing signal separation processing unit 11 extracts a synchronizing signal containing both the vertical synchronizing signals and the horizontal synchronizing signal from the input image signal by means of the amplitude separation processing unit. Then, the synchronizing signal separation processing unit 11 separates the vertical synchronizing signal and the horizontal synchronizing signal from the extracted synchronizing signal by means of the frequency separation processing unit, so that each of the vertical and horizontal synchronizing signals is outputted to the address generation counter 12.

In addition, the synchronizing signal separation processing unit 11 may only extract a synchronizing signal contained in an input image signal, so that it may have any construction other than the construction as described above.

The address generation counter 12 includes therein a counter circuit, counts the number of pulses of the acquired vertical synchronizing signal and horizontal synchronizing signal, generates the address information data based on these synchronizing signals, and provides the address information data to a control unit 13, the first plane memory 18, the second plane memory 19, and the superposing order control unit 20.

The address information data is a position information data in an image for one screen of the input image information data contained in the input image signal, and also is an information data for making the synthesizing image information data synthesized with the input image information data contained in the input image signal, in synchronization with the input image signal in the switch circuit 22. For example, when the input image signal is an image signal corresponding to the NTSC standard, this input image signal is an image signal of an interlace method, so that information for one screen is constituted by 2V (two periods) where one period of the vertical synchronizing signal is assumed to be 1V. In such a case, based on the vertical synchronizing signal and the horizontal synchronizing signal, the address generation counter 12 generates the address information data in which two periods (2V) of the vertical synchronizing signal are considered to be one period. Further, when the input image signal is an image signal of a non-interlaced method, the address generation counter 12 generates the address information data in which one period (1V) of the vertical synchronizing signal is considered to be one period, according to the vertical synchronizing signal and the horizontal synchronizing signal.

In addition, the address information data generation counter 12 may only generate the address information data as described above so as to be provided to the control unit 13, the first plane memory 18, the second plane memory 19, and the superposing order control unit 20, so that it may have any construction other than the construction as described above.

The control unit 13 includes therein a control processing unit, an operation unit, a memory unit, etc. (which are not shown), acquires a program and a data which are supplied from the outside of the image synthesizing apparatus 1 through an input terminal 14, controls a ROM 15 so as to acquire the program and the data which are stored in the ROM 15, or controls a drive 16 so as to acquire the program and the data which are read from a removable media 17 mounted at the drive 16. Then, based on the thus acquired program and data, the control unit 13 controls the first plane memory 18, the second plane memory 19, the superposing order control unit 20, and the switch circuits 21 and 22.

In particular, based on the address information data supplied from the address generation counter 12, the control unit 13 supplies the superposing order control unit 20 with the superposition control information data acquired as the data as described above or the superposition control information data generated by implementing the program acquired as described above, to thereby control operation of the superposing order control unit 20 and operation of the switch circuits 21 and 22 through the superposing order control unit 20.

Further, based on the address information data supplied from the address generation counter 12, the control unit 13 supplies the first plane memory 18 or the second plane memory 19 with the synthesizing image information data which is acquired as the data as described above, non-compressed, and synthesized with the input image information data contained in the input image signal or the synthesizing image information data which is generated by implementing the program acquired as described above, to thereby control operation of the plane memories.

In this case, it is preferable that the amount of data of the synthesizing image information data held by the first plane memory 18 at a time, the amount of data of the synthesizing image information data held by the second plane memory 19 at a time, and the amount of data of the synthesizing image information data corresponding to the control of the superposition control information data (the synthesizing image information data being held by the superposing order control unit 20 at a time) are standardized to the amount of data for one screen of the same image size, for example, so that every data has the same amount, thus allowing the control unit 13 to easily perform a control process and to reduce its load of processing.

The input terminal 14 maybe connected with any apparatus, for example, an input apparatus, such as a keyboard, an imaging apparatus, such as a camera, a recording-medium playback apparatus, such as a disc player and a video-cassette recorder, or an image editing apparatus, such as a personal computer, etc. A variety of information data, such as an image information data inputted from such an apparatuses, and a control information data are supplied through the input terminal 14 to the control unit 13.

The ROM 15 prestores therein a program to be implemented in the control unit 13, data, such as the synthesizing image information data and the superposition control information data, etc. so as to be supplied to the control unit 13 according to the control by means of the control unit 13.

In the drive 16, a removable media 17 constituted by a recording medium, such as a magnetic disk, an optical disc, a magneto-optical disc, a semiconductor memory, etc. is mounted as needed. Being controlled by the control unit 13, the drive 16 reads the program or the data from the mounted removable media 17 so as to supply it to the control unit 13.

The first plane memory 18 has, for example, a storage area constituted by a semiconductor memory, such as a DRAM (Dynamic Random Access Memory) and a control unit which controls input and output of the storage area, so that it holds the non-compressed synthesizing image information data which is supplied from the control unit 13 so as to be selectively synthesized with the input image information data contained in the input image signal, for example, by one screen and outputs the thus held synthesizing image information data to the switch circuit 21, as requested by the switch circuit 21, according to the address information data supplied from the address generation counter 12.

For example, as shown in FIG. 2A, the first plane memory 18 holds, the (bit map form) non-compressed synthesizing image information data which is data on a pixel-by-pixel basis in the storage area 30 by one screen. At this stage, the first plane memory 18 respectively assigns 8 bits to the data 31 on a pixel-by-pixel basis of the synthesizing image information data so as to hold the synthesizing image information data where color information data of each pixel is expressed by 8 bits or less. Assuming that a number of effective pixels of the input image information data contained in the input image signal is 480×720 pixels, the first plane memory 18 uses an area of addresses (of 1-byte unit) 0H through 54600H in the storage area 30, for example, so as to hold the synthesizing image information data of the same image size (480×720 pixels) as the image information data contained in the input image signal.

When the switch circuit 21 requires to output the synthesizing image information data, the first plane memory 18 reads a part, corresponding to the address information data, of the thus held synthesizing image information data and supplies it to the switch circuit 21.

In addition, the amount of data of the synthesizing image information data which is held by the first plane memory 18 at a time may be larger or smaller than that of one screen, and may have any value. Further, a number of bits which is assigned by the first plane memory 18 to the data of each pixel of the synthesizing image information data may be 9 bits or more or may naturally be 7 bits or less.

As shown in FIG. 2A, although it has been described that the first plane memory 18 holds the synthesizing image information data as data on a pixel-by-pixel basis in the non-compressed form (in bit map format), alternatively it may hold the information data where the synthesizing image information data are arranged in a table according to an arrangement of pixels with the same color information data as shown in FIG. 2B, for example.

In FIG. 2B the first plane memory 18 holds the table 40 representing the synthesizing image information data supplied from the control unit 13. The table 40 is a table of the information data on a pixel line where continuous pixels of the same color information data are arranged in a group, and constituted by a start address column 41 which shows a start address of the pixel line on one screen, an end address column 42 which shows an end address of the pixel line on one screen, and a color column 43 which shows color information data of the pixel line.

For example, in the table 40 a row 44 shows that “cccc” is a color information data about a pixel line having addresses “aaaa” through. “bbbb” on one screen of an image corresponding to the synthesizing image information data. In this case, according to a request from the switch circuit 21, the first plane memory 18 reads the information data in the color column of the row corresponding to address information data in the table 40 so as to be supplied to the switch circuit 21 as the synthesizing image information data. In addition the first plane memory 18 may naturally hold not only the color information data but also the information data arranged in a table including luminosity information data.

The second plane memory 19 has the constitution similar to that of the first plane memory 18. Since the constitution as described above with reference to FIG. 2A is applicable also to that of the second plane memory 19, the description of its constitution will not be repeated herein. In addition, the first plane memory 18 and the second plane memory 19 may only hold the synthesizing image information data, so that their storage areas may be constituted by not only a semiconductor memory, a magnetic disk, an optical disc, a magneto-optical disc etc., for example. Further, they may naturally be constituted by other recording media. However, since the first plane memory 18 and the second plane memory 19 must store or output the synthesizing image information data within a short period of time, the storage areas need to be storage areas which can output and input information data at a somewhat high speed, so that it is desirable to constitute them by semiconductor memories.

Further, storage capacities of the first plane memory 18 and the second plane memory 19 may have any amount. However, for example, if the storage capacities are so small as to store the synthesizing image information data only for one line, there is a possibility that a burden of a rewrite process by means of the control unit 13 may become large. Therefore, it is generally desirable that the storage capacities of the first plane memory 18 and the second plane memory 19 are so large as to store the synthesizing image information data by one screen or more at a time. In other words, it is desirable that the storage areas of the first plane memory 18 and the second plane memory 19 are constituted by a DRAM which can provide a mass storage area more inexpensively than an SRAM (Static Random Access Memory).

The superposing order control unit 20 has the memory unit 20A, stores the superposition control information data supplied to the control unit 13. Based on the superposition control information data and the address information data supplied from the address generation counter 12, the superposing order control unit 20 controls the operation of the switch circuits 21 and 22 and further controls a process of synthesizing the synthesizing image information data and the input image information data which are contained in the input image signal.

For example, as shown in FIG. 3A the superposing order control unit 20 holds the superposition control information data 51, for one screen, which controls synthesis of the input image of the input image signal and the synthesizing image on a pixel-by-pixel basis in a storage area 50 of the memory unit 20A. The superposition control information data 51 on a pixel-by-pixel basis is constituted by two bits of bits 61 and 62, and is a control information data on a pixel-by-pixel basis for issuing instructions as to whether or not to synthesize the synthesizing image information data held in the first plane memory 18 or the second plane memory 19 with the input image information data of the input image signal. Assuming that the number of effective pixels of the input image information data contained in the input image signal is 480×720 pixels, the superposing order control unit 20 holds the control information data corresponding to the same image size (480×720 pixels) as the input image information data contained in the input image signal, by means of the area of addresses (of 2-bit unit) OH through 54600H of the storage area 50, for example.

In addition, it is desirable that the amount of data of the superposition control information data which is held by the superposing order control unit 20 is smaller than the amount of data of one synthesizing image information data, as shown in FIG. 3A, for example, because it is possible to reduce the load of processing of the control unit 13. In the case of FIG. 3A, the amount of data for one pixel of the superposition control information data is 2 bits, and it is set so as to become smaller as compared with the amount of data of the synthesizing image information data where the data for one pixel consists of 8 bits.

Based on the address information data, the superposing order control unit 20 refers to the thus held superposition control information data on a pixel-by-pixel basis one by one, so as to control the operation of the switch circuits 21 and 22. Therefore, the superposing order control unit 20 can control the image corresponding to the input image signal on a pixel-by-pixel basis. In addition it can selectively synthesize the image (part to which the position within a screen corresponds in the image of the synthesizing image information data) of the synthesizing image information data stored in either the first plane memory 18 or the second plane memory 19 in the arbitrary places in the screen of the image corresponding to the input image signal.

In addition, the amount of data of the superposition control information data held by the superposing order control unit 20 at a time may be larger or smaller than that of one screen, and may have any value. Further, a number of bits which is assigned by the superposing order control unit 20 to each of the control information data 20A of a bit unit may be any bit.

Based on the arrangement of pixels with the same image information data to be synthesized, such as may be shown in FIG. 3B, for example, other than the method as shown in FIG. 3A, the superposing order control unit 20 may hold the information data (information data which are obtained by arranging, in a table, the transition points where the control changes) which are obtained by arranging the superposition control information data in a table.

In FIG. 3B, the superposing order control unit 20 holds the table 70 representing the superposition control information data supplied from the control unit 13. The table 70 is a table of the superposition control information data for every pixel line which is obtained by arranging the control information data in groups, with respect to the continuous pixels of the same synthesizing image information data. The table is constituted by a start address column 71 which shows a start address of the pixel line on one screen, an end address column 72 which shows an end address of the pixel line on one screen, and a selected synthesizing image information data column 73 which shows an synthesizing image information data selected in the pixel line.

For example, in the table 70, a row 81 shows that the synthesis image information data which are synthesized with a pixel line having the addresses “aaaa” through “bbbb” on one screen of the image corresponding to the synthesizing image information data are the synthesizing image information data held in the first plane memory 18. In this case, the superposing order control unit 20 refers to the information data on the selected synthesizing image information data column 73 of the row corresponding to the address information data in the table 70, and controls the switch circuits 21 and 22 such that the synthesizing image information data may be synthesized with the input image information data contained in the input image signal.

The switch circuit 21 is a switch circuit provided with two inputs and one output, so as to be supplied with the output from the first plane memory 18 or the second plane memory 19. Being controlled by the superposing order control unit 20, the switch circuit 21 switches connections on the input side so as to selectively connect either the first plane memory 18 or the second plane memory 19 to the switch circuit 22, and requires the connected plane memory to output the synthesizing image information data. In other words, based on the control by means of the superposing order control unit 20, the switch circuit 21 carries out the control such that the synthesis image information data may be supplied to the switch circuit 22 from either the first plane memory 18 or the second plane memory 19.

The switch circuit 22 is a switch circuit provided with two inputs and one output, so as to be supplied with the image input signal and the output from the switch circuit 21. Being controlled by the superposing order control unit 20, the switch circuit 22 switches the connections on the input side, and selectively outputs either the supplied image input signal or the output through the switch circuit 21 (the output from the first plane memory 18 or the second plane memory 19) to the outside of the image synthesizing apparatus 1 as the output image signal.

Now, the operation will be described. The non-compressed input image signal inputted into the image synthesizing apparatus is supplied to the synchronizing signal separation processing unit 11, and subjected to extraction of the synchronizing signals, such as the vertical synchronizing signal and the horizontal synchronizing signal. Based on the features, such as the amplitude, the frequency, etc., the synchronizing signal separation processing unit 11 extracts the synchronizing signals contained in the input image signal. The extracted synchronizing signal is supplied to the address generation counter 12 so as to be converted into the address information data which indicates a position on a screen and is supplied to the control unit 13, the first plane memory 18, the second plane memory 19, and the superposing order control unit 20.

The control unit 13 acquires the program and the data through the input terminal 14, or from the ROM 15 or the removable media 17 mounted at the drive 16, and implements the program, for example, so that the synthesizing image information data is supplied to the first plane memory 18 or the second plane memory 19 at the timing based on the address information data supplied from the address generation counter 12.

The control unit 13 supplies the first plane memory 18 and the second plane memory 19 with the synthesizing image information data which are different from each other, whereby, as will be described hereafter, the images inserted into a part or the whole of the image corresponding to the input image signal can be switched without applying a load to the control unit 13. In addition, the control unit 13 can supply a new synthesizing image information data to the plane memory which is not performing an output process of the synthesizing image information data. Therefore, the control unit 13 can supply the new synthesizing image information data at a timing other than a vertical blanking period of the input image information data contained in the input image signal, for example, a period when the other plane memory is performing the output process of the synthesizing image information data, whereby the load of the process of providing the synthesizing image information data can be reduced. Accordingly, performance necessary for the control unit 13 can be lowered, so that the manufacturing costs of the control unit 13 can be reduced.

In addition, although it has been described that a number of plane memories is two in FIG. 1, it is not limited to this, and the number may naturally be three or more. The first plane memory 18 or the second plane memory 19 holds the synthesis image information data thus supplied by the control unit 13. According to a request from the switch circuit 21, it outputs a part, corresponding to the address information data, of the held synthesizing image information data to the switch circuit 21.

Further, the control unit 13 acquires the program and the data through the input terminal 14, or from the ROM 15 or the removable media 17 mounted at the drive 16, and implements the program, for example, so that the superposition control information data is supplied to the superposing order control unit 20 at a timing based on the address information data supplied from the address generation counter 12.

The superposing order control unit 20 holds, in the built-in memory unit 20A, the superposition control information data supplied from the control unit 13, refers to the held superposition control information data, and controls the operation of the switch circuits 21 and 22 according to the address information data supplied from the address generation counter 12. Based on the control by means of the superposing order control unit 20, the switch circuit 21 reads either of the synthesizing image information data which are stored in the first plane memory 18 and the second plane memory 19 so as to be supplied to the switch circuit 22. Based on the control by means of the superposing order control unit 20, the switch circuit 22 selects either the input image signal or the output from the switch circuit 21, and outputs it to the outside of the image synthesizing apparatus 1 as the output image signal.

In this way, the image synthesizing apparatus 1 selectively synthesizes the synthesizing image information data with the input image information data contained in the input image signal, so as to output is as the output image signal. Further, the image synthesizing apparatus 1 can easily synthesize the plurality of image information data, with the circuit size and the manufacturing costs remaining reduced.

Next, with reference to flow charts in FIG. 4 and FIG. 5, an image synthesis process by means of the image synthesizing apparatus 1 as shown in FIG. 1 will be described, further referring to FIGS. 6A to 6C and FIGS. 7A to 7C, as needed.

Firstly, in step S1 the control unit 13 determines whether or not to generate a first synthesizing image information data. When it is determined to be generated, the control unit 13 moves the process to step S2 so as to generate the first synthesizing image information data. Then, the control unit 13 supplies the first plane memory 18 with the generated first synthesizing image information data. Being supplied with the first synthesizing image information data, the first plane memory 18 holds the supplied first synthesizing image information data in step S3, and moves the process to step S4.

For example, when the input image corresponding to the input image information data contained in the input image signal is the input image 91 as shown in FIG. 6A, the control unit 13 generates the first synthesizing image information data corresponding to a first synthesizing image 101 (as shown in FIG. 6B) of the same image size as the input image 91, so as to be supplied to the first plane memory 18. The first synthesizing image 101 is constituted by a area 102 containing characters “XYZ”, a area 103 containing character “123”, and the other area 104. In other words, the first synthesizing image 101 is an image for inserting the characters “XYZ” and “123” into the input image 91. In step S3, the first plane memory 18 holds the first synthesizing image information data corresponding to the supplied first synthesizing image 101.

Further, in step S1 when it is determined not to generate the first synthesizing image information data, the control unit 13 controls the processes in steps S2 and S3 so as to be skipped, and moves the process to step S4. In step S4 the control unit 13 determines whether or not to generate the second synthesizing image information data. When it is determined to be generated, the control unit 13 moves the process to step S5 and generates the second synthesizing image information data. The control unit 13 supplies the generated second synthesizing image information data to the second plane memory 19. Being supplied with the second synthesizing image information data, the second plane memory 19 holds, in step S6, the supplied second synthesizing image information data, and moves the process to step S7.

For example, the control unit 13 generates the second synthesizing image information data corresponding to a second synthesizing image 111 (as shown in FIG. 6C) of the same image size as the input image 91, so as to be supplied to the second plane memory 19. The second synthesizing image 111 is constituted by a area 112 containing the characters “ABC”, a area 113 containing the character of “456” and the other area 114. In other words, the second synthesizing image 111 is an image for inserting the characters “ABC” and “456” in the input image 91.

For the sake of brevity in the description, the position and size of the area 112 in the second synthesizing image 111 as shown in FIG. 6C are caused to correspond to those of the area 102 in the first synthesizing image 101 as shown in FIG. 6B. Similarly, the position and size of the area 113 in the second synthesizing image 111 are caused to correspond to those of the area 103 in the first synthesizing image 101. The positions, sizes, etc. of these areas may naturally be independent of one another.

In step S6 the second plane memory 19 hold the second synthesizing image information data corresponding to the supplied second synthesizing image 111. Further, in step S4 when it is determined not to generate the second synthesizing image information data, the control unit 13 controls the processes in steps S5 and S6 so as to be skipped, and moves the process to step S7.

In step S7 the control unit 13 determines whether or not to generate the superposition control information data which are control information data for synthesizing the synthesizing image information data with the input image information data contained in the input image signal (inserting the image corresponding to the synthesizing image information data into the image corresponding to the input image signal). When it is determined to generate the superposition control information data, the control unit 13 moves the process to step S8, and generates the superposition control information data so as to be supplied to the superposing order control unit 20. Being supplied with the superposition control information data, the superposing order control unit 20 holds, in step S9, the superposition control information data, and moves the process to step S11 of FIG. 5.

For example, the control unit 13 generates the superposition control information data corresponding to the image 121 (as shown in FIG. 7A) of the same image size as the input image 91 so as to supply it to the superposing order control unit 20. The image 121 corresponding to superposition control information data is constituted by: a area 122 which exists in the same position and has the same size as the area 102 of the first synthesizing image 101 as shown in FIG. 6B, and the area 112 of the second synthesizing image 111 as shown in FIG. 6C; a area 123 which exists in the same position and has the same size as the area 103 of the first synthesizing image 101 as shown in FIG. 6B, and the area 113 of the second synthesizing image 111 as shown in FIG. 6C; and the other area 124 (which exists in the same position and has the same size as the area 104 of the first synthesizing image 101 as shown in FIG. 6B, and the area 114 of the second synthesizing image 111 as shown in FIG. 6C.)

In FIG. 7A, the superposition control information data are such that the first synthesizing image information data held in the first plane memory 18 is outputted into the area 122 of the image 121, the second synthesizing image information data held in the second plane memory 19 is outputted into the area 123, and the input image information data is outputted into the area 124. Based on such superposition control information data, the superposing order control unit 20 controls the switch circuits 21 and 22, as will be described later, so as to output either the first synthesizing image information data, the second synthesizing image information data, or the input image information data.

Now, returning to FIG. 4, in step S7 when it is determined not to generate the superposition control information data, the control unit 13 controls the processes in steps S8 and S9 so as to be skipped, and moves the process to step S11 of FIG. 5. In step S11 of FIG. 5 the synchronizing signal separation processing unit 11 separates the synchronizing signal from the supplied input image signal, and supplies the separated synchronizing signal to the address generation counter 12. In step S12, based on the supplied synchronizing signal, the address generation counter 12 generates the address information data where one screen is considered to have one period, so as to be supplied to the control unit 13, the first plane memory 18, the second plane memory 19, and the superposing order control unit 20.

Having acquired the superposition control information data from the control unit 13, the superposing order control unit 20 specifies a pixel of attention based on the address information data in step S13, and determines, at the pixel of attention, whether or not to synthesize the first synthesizing image information data with the image information data contained in the input image signal. When it is determined to synthesize the first synthesizing image information data, the superposing order control unit 20 controls the switch circuits 21 and 22 so as to output the first synthesizing image information data as the output image signal in step S14. In other words, based on the control by means of the superposing order control unit 20, the switch circuit 21 connects the first plane memory 18 to the switch circuit 22, acquires the first synthesizing image information data from the first plane memory 18, and supplies it to the switch circuit 22. Based on the control by means of the superposition control unit 20 as described above, the switch circuit 22 connects the output from the switch circuit 21 to the output side, and outputs the first synthesizing image information data supplied through the switch circuit 21 to the outside of the image synthesizing apparatus 1 as the output image signal. Having outputted the first synthesizing image information data, the switch circuit 22 moves the process to step S18.

In step S13 when it is determined not to synthesize the first synthesizing image information data at the pixel of attention, the superposing order control unit 20 moves the process to step S15, and determines, at the pixel of attention, whether or not to synthesize the second synthesizing image information data with the image information data contained in the input image signal. When it is determined to synthesize the second synthesizing image information data, the superposing order control unit 20 moves the process to step S16, and controls the switch circuits 21 and 22 so as to output the second synthesizing image information data as the output image signal. In other words, based on the control by means of the superposing order control unit 20, the switch circuit 21 connects the second plane memory 19 to the switch circuit 22, and acquires the second synthesizing image information data from the second plane memory 19 so as to be supplied to the switch circuit 22. Based on the control by means of the superposition control unit 20 as described above, the switch circuit 22 connects the output from the switch circuit 21 to the output side, and outputs the second synthesizing image information data supplied through the switch circuit 21 to the outside of the image synthesizing apparatus 1 as the output image signal. Having outputted the second synthesizing image information data, the switch circuit 22 moves the process to step S18.

In step S15 when it is determined not to synthesize the second synthesizing image information data at the pixel of attention, the superposing order control unit 20 moves the process to step S17, controls the switch circuits 21 and 22 so as to output the input image information data contained in the input image signal as the output image signal. In other words, based on the control by means of the superposition control unit 20 as described above, to the output side the switch circuit 22 connects the input on the side into which the input image signal is inputted, and outputs the input image information data contained in the input image signal which is inputted from the outside of the image synthesizing apparatus 1 to the outside of the image synthesizing apparatus 1 as the output image signal. Having outputted the input image information data, the switch circuit 22 moves the process to step S18.

For example, according to the control by means of the superposing order control unit 20 based on the superposition control information data corresponding to the screen 121 as shown in FIG. 7A, the switch circuit 21 selectively outputs the first synthesizing image information data corresponding to the first synthesizing image 101 as shown in FIG. 6B and the second synthesizing image information data corresponding to the second synthesizing image 111 as shown in FIG. 6C, so that the synthesizing image information data corresponding to the synthesizing image 131 as shown in FIG. 7B is outputted to the switch circuit 22.

In FIG. 7B, the synthesizing image 131 is constituted by a area 132 corresponding to the area 122, a area 133 corresponding to the area 123, and a area 134 corresponding to the area 124. In the area 132, the image of the area 102 of the first synthesizing image 101 is outputted. In the area 133, the image of the area 113 of the second synthesizing image 111 is outputted. In the area 134, neither the first synthesizing image 101 nor the second synthesizing image 111 is outputted.

According to the control by means of the superposing order control unit 20 based on the superposition control information data corresponding to the screen 121 as shown in FIG. 7A, the switch circuit 22 selectively outputs the input image information data corresponding to the input image 91 as shown in FIG. 6A and the synthesizing image information data corresponding to the synthesizing image 131 as shown in FIG. 7B, so that the output image information data corresponding to the output image 141 as shown in FIG. 7C is outputted to the outside of the synthesis image apparatus 1 as the output image signal.

In FIG. 7C the output image 141 is constituted by a area 142 corresponding to the area 122, a area 143 corresponding to the area 123, and a area 144 corresponding to a area 124. In the area 142, the image of the area 102 of the first synthesizing image 101 is outputted. In the area 133, the image of the area 113 of the second synthesizing image 111 is outputted. In the area 134, the image of the input image 91 is outputted.

In this way, each part of the image synthesizing apparatus 1 generates the output image information data which is selectively synthesized, for arbitrary areas, from the first synthesizing image information data, the second synthesizing image information data, and the input image information data, so as to be outputted to the outside of the image synthesizing apparatus 1 as the output image signal.

Now returning to FIG. 5, in step S18 the superposing order control unit 20 determines whether or not all the pixels in a frame, i.e. the data for one screen have been processed. When it is determined that the pixels for one period of address information data have not been processed and all the pixels in the frame have not been processed yet, it moves the process to step S19, pays attention to the next pixel according to the address information data, and returns the process to step S13, and the subsequent processes are repeated. In other words, each part of the image synthesizing apparatus 1 repeats the processes in step S13 through step S19 so that one frame of the image information data are processed on a pixel-by-pixel basis. In step S18 when it is determined that all the pixels in the frame have been processed, the superposing order control unit 20 moves the process to step S20.

In step S20 the control unit 13 determines whether or not to terminate the image synthesis process. When the image information data corresponding to the following frame is inputted as the input image signal and it is determined not to terminate the image synthesis process, the process is returned to step S1 of FIG. 4, the subsequent processes are repeated. In other words, each part of the image synthesizing apparatus 1 repeats the processes in step S1 through step S20 so that the image synthesis process is performed for every frame with respect to all the input image information data contained in the input image signal. Thus, the image synthesizing apparatus 1 may, for every frame, generate the output image information data which are obtained by selectively synthesizing the first synthesizing image information data, the second synthesizing image information data, and the input image information data, for every arbitrary area, so that the output image information data may be outputted to the outside of the image synthesizing apparatus 1 as the output image signal. In other words, for every arbitrary area, the image synthesizing apparatus 1 can switch the synthesizing images which are inserted in the input image. In this case, unlike a conventional apparatus, the control unit 13 does not create the synthesizing image information data or perform the control process so that the created synthesizing image information data may be synthesized with the input image information data. It may only supply the superposition control information data to the superposing order control unit 20 so as to easily switch the synthesizing images.

In step S20, for example, when the input of the input image signal is stopped and it is determined to terminate the image synthesis process, the control unit 13 moves the process to step S21, and carries out a termination process so as to terminate the image synthesis process. In this way, each part of the image synthesizing apparatus 1 performs the image synthesis process, whereby the image synthesizing apparatus 1 can easily synthesize the plurality of image information data, with the circuit size and the manufacturing costs remaining reduced.

FIG. 8 is a block diagram showing another example of structure of the image synthesizing apparatus to which the present invention is applied. In FIG. 8 the same reference numerals are used to indicate parts corresponding to FIG. 1 and the description of them will not be repeated.

In FIG. 8, the image synthesizing apparatus 150 is, for example, an apparatus in which a part or the whole of an image corresponding to the input image signal such as the image signal included in the television signal corresponding to the NTSC standard or the PAL standard is superimposed (or mixed) with another image showing a character, graphics, etc., so that the resulting image is outputted as an output image signal. In other words, the image synthesizing apparatus 150 synthesizes and outputs the input image information data contained in the input image signal and the synthesizing image information data which is another image information data such that the image corresponding to the two image information data may be superimposed on (or mixed with) each other. At this stage, the image synthesizing apparatus 150 can synthesize the image information data such that, in the plurality of areas in the screen of the image corresponding to the input image signal, the character, graphics, etc. may be synthesized independently of each other for every area. For example, image synthesizing apparatus 150 can change a part of other images on which the image corresponding to the input image signal is superimposed (or mixed), further switch it to another image, or move it to another position. Also, the image synthesizing apparatus 150 can change tints of the two superimposed (mixed) images.

Similar to the control unit 13 of FIG. 1, the control unit 151 of the image synthesizing apparatus 150 includes the control processing unit, the operation unit, the memory unit, etc., which are not shown but built in. The control unit 151 acquires the program and data which are supplied from the outside of the image synthesizing apparatus 150 through the input terminal 14, controls the ROM 15 so as to acquire the program and data which are stored in the ROM 15, or controls the drive 16 so as to acquire the program and data which are read out of the removable media 17 mounted at the drive 16. Based on the thus acquired program and data, the control unit 150 controls the first plane memory 18, the second plane memory 19, the synthesizing ratio control unit 152, and the multipliers 153 through 155.

In particular, based on the address information data supplied from the address generation counter 12, the control unit 151 supplies the synthesizing ratio control unit 152 with the synthesizing ratio control information data acquired as the data as described above or the synthesizing ratio control information data generated by performing the program acquired as described above, so as to control operation of the synthesizing ratio control unit 152 and operation of the multipliers 153 through 155 via the synthesizing ratio control unit 152.

In addition, similar to the control unit 13 of FIG. 1, the control unit 151 supplies the non-compressed synthesizing image information data which is acquired as data in the manner as described above and is synthesized with the input image information data contained in the input image signal, or the synthesizing image information data generated by performing the thus acquired program, to the first plane memory 18 or the second plane memory 19, based on the address information data supplied from the address generation counter 12, so that operation of the first plane memory 18 and the second plane memory 19 is controlled.

In this case, it is preferable that the amount of data of the synthesizing image information data held by the first plane memory 18 at a time, the amount of data of the synthesizing image information data held by the second plane memory 19 at a time, and the amount of data of the synthesizing image information data corresponding to control of the synthesizing ratio control information data held by the synthesizing ratio control unit 152 at a time are standardized to the amount of data for one screen of the same image size, for example, so as to be the same amount of data, thus allowing the control unit 151 to easily perform a control process and to reduce its load of processing.

The synthesizing ratio control unit 152 has the memory unit 152A, and stores the synthesizing ratio control information data supplied from the control unit 151. Based on the synthesizing ratio control information data, the address information data supplied from the address generation counter 12, and the synthesis image information data supplied from the first plane memory 18 or the second plane memory 19, the synthesizing ratio control unit 152 controls operation of the multipliers 153 through 155, and controls synthesis of the input image information data contained in the input image signal and the synthesizing image information data.

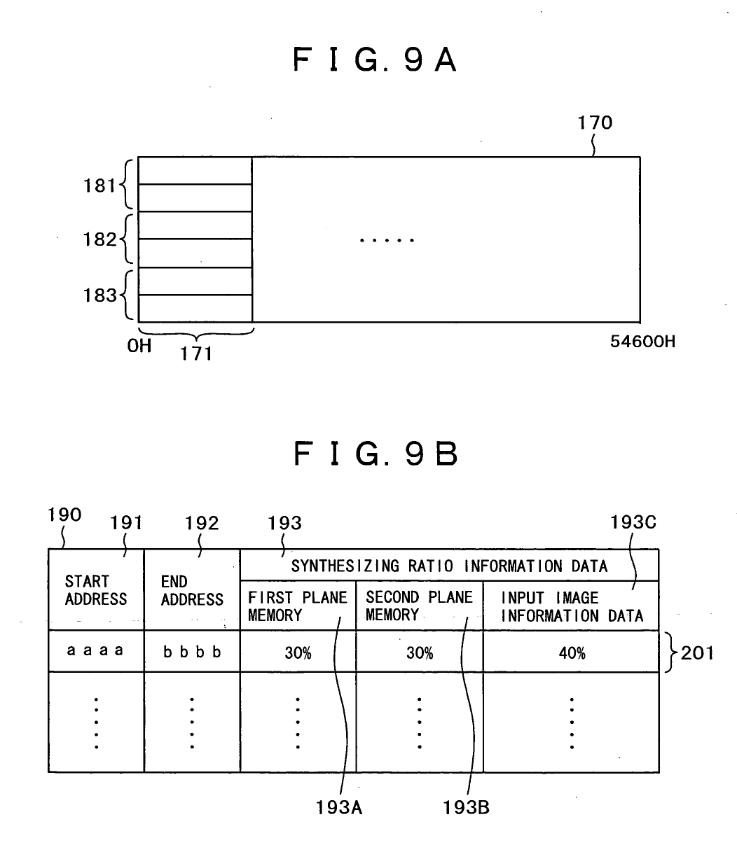

As shown in FIG. 9A, for example, the synthesizing ratio control unit 152 holds, in a storage area 170 of its memory unit 152A, one screen of the synthesizing ratio control information data 171 which controls synthesis (mixture) of the input image of the input image signal and the synthesizing image on a pixel-by-pixel basis. The synthesizing ratio control information data 171 on a pixel-by-pixel basis is constituted by 6 bits and is the control information data on a pixel-by-pixel basis for specifying synthesizing ratios of the synthesizing image information data held at the first plane memory 18 and the second plane memory 19 and those of the input image information data contained in the input image signal. In the case of FIG. 9A, a bit group 181, which is two bits out of 6 bits constituting the synthesizing ratio control information data 171 on a pixel-by-pixel basis, holds the information data for specifying the synthesizing ratio of the synthesizing image information data held at the first plane memory 18; a bit group 182 which is similarly constituted by 2 bits holds the information data for specifying the synthesizing ratio of the synthesizing image information data held at the second plane memory 19; further, a bit group 183 which is constituted by the remaining 2 bits holds the information data for specifying the synthesizing ratio of the input image information data.

In other words, in this case, the synthesizing ratios of the synthesizing image information data held at the first plane memory 18 and the second plane memory 19 and those of the input image information data contained in the input image signal can respectively be set by way of four grades. In addition, the setup of the synthesizing ratio for each image information data may be carried out by means of any number of grades, so that any number of bits may be assigned to the specification of the synthesizing ratio for each image information data. Further, the number of bits assigned to the specification of the synthesizing ratio for each image information data may naturally be a mutually different number. In other words, in FIG. 9A, any number of the bits may constitute the synthesizing ratio control information data 171 on a pixel-by-pixel basis.

In addition, the amount of data of the synthesizing ratio control information data itself held by the synthesizing ratio control unit 152 (the amount of data by way of the number of the bits which constitute the synthesizing ratio control information data 171 on a pixel-by-pixel basis) may naturally be any size, however, the smaller possible one can more effectively reduce the load of processing of the control unit 151. As described above, the larger the amount of data of synthesizing ratio control information data (the amount of data by the number of the bits which constitute the synthesizing ratio control information data 171 on a pixel-by-pixel basis) is, the more finely the specification of the synthesizing ratio for each image information data can be set up.

The synthesizing ratio control unit 152 refers to the thus held synthesizing ratio control information data on a pixel-by-pixel basis one by one based on the address information data, controls the operation of the multipliers 153 through 155, and multiplies each image information data with a synthesizing ratio which is a coefficient according to each synthesizing ratio. Therefore, the synthesizing ratio control unit 152 can control the image corresponding to the input image signal on a pixel-by-pixel basis, and mix and synthesize the image of the synthesizing image information data stored by either the first plane memory 18 or the second plane memory 19 (part, of the image of the synthesizing image information data, to which a position in a screen corresponds) in an arbitrary position in the screen of the image corresponding to the input image signal.

In addition, the amount of data of the synthesizing ratio control information data held by the synthesizing ratio control unit 152 at a time (the amount of data by way of the number of the synthesizing ratio control information data 171 on a pixel-by-pixel basis) may be larger or smaller than that of one screen, or may have any value.

Further, other than the method as shown in FIG. 9A, the synthesizing ratio control unit 152 may hold the information data in table obtained by arranging the synthesizing ratio control information data according to the arrangement of the pixels with the same synthesizing ratio of the image information data to be synthesized, as shown in FIG. 9B, for example. In FIG. 9B the synthesizing ratio control unit 152 holds the table 190 representing the synthesizing ratio control information data supplied from the control unit 151. The table 190 is a table of the synthesizing ratio control information data for every pixel line in which the control information data are arranged in group with respect to the continuous pixels of the same synthesizing ratio of the image information data to be synthesized. It is constituted by a start address column 191 which shows a start address of the pixel line on one screen, an end address column 192 which shows an end address of the pixel line on one screen, and a synthesizing ratio information data column 193 which shows a synthesizing ratio of the synthesizing image information data in the pixel line.

A column which shows a synthesizing ratio for each image information data is provided in the synthesizing ratio information data column 193. In the case of FIG. 9B, the synthesizing ratio information data 193 is constituted by a first plane memory column 193A which shows the synthesizing ratio of the synthesizing image information data held at the first plane memory 18, a second plane memory column 193B which shows the synthesizing ratio of the synthesizing image information data held at the second plane memory 19, and an input image information data column 193C which shows the synthesizing ratio of input image information data.

For example, in the table 190, a line 201 shows that with respect to the pixel line having the addresses “aaaa” through “bbbb”, on one screen, of the image corresponding to the input image information data, the synthesizing image information data held at the first plane memory 18 is mixed at a synthesizing ratio of 30%, the synthesizing image information data held at the second plane memory 19 is mixed at a synthesizing ratio of 30%, and the input image information data is mixed a synthesizing ratio of 40%.

In such a case, the synthesizing ratio control unit 152 refers, in the table 190, to the information data on the synthesizing ratio information data column 193 on a line corresponding to an address information data, controls the multiplier 153 through 155 so as to synthesize each image information data at a specified synthesizing ratio and to multiply each image information data with the synthesizing ratio according to each synthesizing ratio.

In addition, the synthesizing ratio control unit 152 refers to the synthesis image information data supplied from the first plane memory 18 or the second plane memory 19. As for these synthesis image information data, when a synthesis image does not exist in the pixel in the position corresponding to the current address information data, the multipliers 153 or 154 is controlled so that the image information data may not be mixed. In other words, in this case, the synthesizing ratio control unit 152 controls the multiplier 153 or 154 corresponding to the image information data so that the image information data may be multiplied by a synthesizing ratio having a value of “0”. In this way, only for a part in which a synthesis image actually exists, the image synthesizing apparatus 1 can mix its image information data with the input image information data, thus preventing the output image from degrading in the quality of images.

The multiplier 153 multiplies the synthesizing image information data supplied from the first plane memory 18 with the synthesizing ratio acquired from the synthesizing ratio control unit 152, and the resulting product is supplied to the adder 156. The multiplier 154 multiplies the synthesizing image information data supplied from the second plane memory 19 with the synthesizing ratio acquired from the synthesizing ratio control unit 152, and the resulting product is supplied to the adder 156. The multiplier 155 multiplies the input image information data with the synthesizing ratio acquired from the synthesizing ratio control unit 152, and the resulting product is supplied to the adder 156.

The adder 156 adds together the respective image information data supplied from the multipliers 153 through 155, and the resulting sum as an output image signal is outputted to the outside of the image synthesizing apparatus 150.

Now, the operation will be described. The non-compressed input image signal inputted into the image synthesizing apparatus 150 is supplied to the synchronizing signal separation processing unit 11, and subjected to extraction of the synchronizing signals, such as the vertical synchronizing signal and the horizontal synchronizing signal. Based on the features, such as the amplitude, the frequency, etc., the synchronizing signal separation processing unit 11 extracts the synchronizing signals contained in the input image signal. The extracted synchronizing signals are supplied to the address generation counter 12 so as to be converted into the address information data which indicate positions on a screen and are supplied to the control unit 151, the first plane memory 18, the second plane memory 19, and the synthesizing ratio control unit 152.

The control unit 151 acquires the program and the data through the input terminal 14, or from the ROM 15 or the removable media 17 mounted at the drive 16, and implements the program, for example, so that the synthesizing image information data is supplied to the first plane memory 18 or the second plane memory 19 at the timing based on the address information data supplied from the address generation counter 12.

The control unit 151 supplies the first plane memory 18 and the second plane memory 19 with the synthesizing image information data which are different from each other, whereby the image mixed with a part or the whole of the image corresponding to the input image signal can be switched without applying a load to the control unit 151.

In addition, the control unit 151 can supply a new synthesizing image information data to the plane memory which is not performing the output process of the synthesizing image information data. Therefore, the control unit 151 can supply the new synthesizing image information data to the plane memory, for example, in which the output process of the held synthesizing image information data has been finished at a timing other than the vertical blanking period of the input image information data contained in the input image signal, so that the load of provision processing of the synthesizing image information data can be reduced. Accordingly, performance necessary for the control unit 13 can be lowered, so that manufacturing costs of the control unit 151 can be reduced. In addition, although it has been described that the number of plane memories is two in FIG. 8, it is not limited to this, and the number may naturally be three or more.

Being supplied with the synthesis image information data from the control unit 151, the first plane memory 18 and the second plane memory 19 hold the synthesis image information data, so that at a timing based on the supplied address information data, part of the held synthesizing image information data, the part corresponding to the address information data, are outputted to the multiplier 153 or 154 and supplied to the synthesizing ratio control unit 152.

Further, the control unit 151 acquires the program and the data through the input terminal 14, or from the ROM 15 or the removable media 17 mounted at the drive 16, and implements the program, for example, so that the synthesizing ratio control information data is supplied to the synthesizing ratio control unit 152 at a timing based on the address information data supplied from the address generation counter 12.

Being supplied with the synthesizing ratio information data from the control unit 151, the synthesizing ratio control unit 152 holds the synthesizing ratio information data in the built-in memory unit 152A. Based on the address information data supplied from the address generation counter 12, it refers to the held synthesizing ratio control information data, and supplies the synthesizing ratio to the multipliers 153 through 155 so as to control their operation.

In this case, the synthesizing ratio control unit 152 refers to the synthesizing image information data supplied from the first plane memory 18 or the second plane memory 19 and determines whether or not an image to be mixed exists in the pixel corresponding to the current address information data. When it is determined not to be present, the synthesizing ratio control unit 152 supplies the synthesizing ratio having the value of “0” to the multiplier 153 or 154 and controls it so as not to mix the synthesizing images. In other words, with respect to the synthesizing ratio control information data, even in a area which is specified to be mixed with the synthesizing image information data, the synthesizing ratio control unit 152 controls the synthesizing image information data so as not to be mixed with the synthesizing image when the images to be actually synthesized (for example, the character, graphics, etc.) do not exist in the synthesizing image.

Being supplied with the synthesizing image information data from the first plane memory 18, the multiplier 153 multiplies the synthesizing image information data with the synthesizing ratio supplied from the synthesizing ratio control unit 152, and the resulting product is supplied to the adder 156. Being supplied with the synthesizing image information data from the second plane memory 19, the multiplier 154 multiplies the synthesizing image information data with the synthesizing ratio supplied from the synthesizing ratio control unit 152, and the resulting product is supplied to the adder 156. Being supplied with the input image information data (the input image signal), the multiplier 155 multiplies the input image information data with the synthesizing ratio supplied from the synthesizing ratio control unit 152, and the resulting product is supplied to the adder 156.

The adder 156 adds together the image information data supplied from the multipliers 153 through 155 on a pixel-by-pixel basis, generates the output image information data so as to be outputted to the outside of the image synthesizing apparatus 150 as the output image signal.

In this way, the image synthesizing apparatus 150 synthesizes and mixes the synthesizing image information data with the input image information data contained in the input image signal so as to be outputted as the output image signal. Further, the image synthesizing apparatus 150 can easily synthesize the plurality of image information data, with the circuit size and the manufacturing costs remaining reduced.

Next, with reference to flow charts of FIG. 10 and FIG. 11, image synthesis processing by means of the image synthesizing apparatus 150 in FIG. 8 will be described, further referring to FIGS. 12A to 12C, FIGS. 13A to 13C and FIGS. 14A to 14B as needed.

Firstly, in step S41 the control unit 151 determines whether or not to generate the first synthesizing image information data. When it is determined to generate it, the control unit 151 moves the process to step S42 so as to generate the first synthesizing image information data. Then, the control unit 151 supplies the thus generated first synthesizing image information data to the first plane memory 18. Being supplied with the first synthesizing image information data, the first plane memory 18 holds, in step S43, the supplied first synthesizing image information data, and moves the process to step S44.

For example, when the input image corresponding to the input image information data contained in the input image signal is an input image 211 as shown in FIG. 12A, the control unit 151 generates the first synthesizing image information data corresponding to a first synthesizing image 221 of the same image size as the input image 211 as shown in FIG. 12B, and supplies it the first plane memory 18. The first synthesizing image 221 is constituted by a area 222 containing a circular pattern (solid black), a area 223 containing a pattern (in concentric circles) of a solid black doughnut, and the other area 224. In other words, the first synthesizing image 221 is an image for synthesizing (or mixing) the input image 211 with the patterns (in concentric circles) of the solid black doughnut and the solid black circle. In step S43 the first plane memory 18 holds the first synthesizing image information data corresponding to the supplied first synthesizing image 221.

In step S41 when it is determined not to generate the first synthesizing image information data, the control unit 151 controls the processes in steps S42 and S43 so as to be skipped, and moves the process to step S44.

In step S44 the control unit 151 determines whether or not to generate the second synthesizing image information data. When it is determined to generate it, the control unit 151 moves the process to step S45 and generates the second synthesizing image information data. The control unit 151 supplies the thus generated second synthesizing image information data to the second plane memory 19. In step S46, being supplied with the second synthesizing image information data, the second plane memory 19 holds the supplied second synthesizing image information data, and moves the process to step S47.

For example, as shown in FIG. 12C, the control unit 151 generates the second synthesizing image information data corresponding to the second synthesizing image 231 of the same image size as the input image 211, and supplies it to the second plane memory 19. The second synthesizing image 231 is constituted by a area 232 containing a solid black triangle, a area 233 containing a solid black quadrangle, and the other area 234. In other words, the second synthesizing image 231 is the image for synthesizing (or mixing) the input image 231 with the solid black triangle and the solid black quadrangle.

For the sake of brevity in the description, the position and size of the area 232 in the second synthesizing image 231 as shown in FIG. 12C are caused to correspond to those of the area 222 in the first synthesizing image 221 as shown in FIG. 12B. Similarly, the position and size of the area 233 in the second synthesizing image 231 are caused to correspond to those of the area 223 in the first synthesizing image 221. The positions, sizes, etc. of these areas may naturally be independent of one another.

In step S46 the second plane memory 19 holds the second synthesizing image information data corresponding to the supplied second synthesizing image 231. In step S44 when it is determined not to generate the second synthesizing image information data, the control unit 151 controls the processes in steps S45 and S46 so as to be skipped, and moves the process to step S47.

In step S47 the control unit 151 determines whether or not to generate the synthesizing ratio control information data which are the control information data for synthesizing the input image information data contained in the input image signal with the synthesizing image information data (for mixing the image corresponding to the input image signal with the image corresponding to the synthesizing image information data). When it is determined to generate the synthesizing ratio control information data, the control unit 151 moves the process to step S48, and generates the synthesizing ratio control information data so as to be supplied to the synthesizing ratio control unit 152. In step S49, being supplied with the synthesizing ratio control information data, the synthesizing ratio control unit 152 holds the synthesizing ratio control information data, and moves the process to step S51 of FIG. 11.

For example, as shown in FIG. 13A, the control unit 151 generates the synthesizing ratio control information data corresponding to the image 241 of the same image size as the input image 211 of a pattern hatched diagonally upward to the right in the figure, and supplies it to the synthesizing ratio control unit 152. The image 241 corresponding to synthesizing ratio control information data is divided into a area 242, a area 243, and a area 244 which is the other area. In each area, the synthesizing ratio of image information data is specified independently of one another.

The position and size of the area 242 correspond to those of the area 222 of the first synthesizing image 221 as shown in FIG. 12B and those of the area 232 of the second synthesizing image 231 as shown in FIG. 12C. The position and size of the area 243 correspond to those of the area 223 of the first synthesizing image 221 as shown in FIG. 12B and those of the area 233 of the second synthesizing image 231 as shown in FIG. 12C. The position and size of the area 242 correspond to those of the area 224 of the first synthesizing image 221 as shown in FIG. 12B and those of the area 234 of the second synthesizing image 231 as shown in FIG. 12C.

In the area 242, the synthesizing ratio control information data corresponding to the image 241 as shown in FIG. 13A is set up so as to mix and output 50% of the first synthesizing image information data, 30% of the second synthesizing image information data, and 20% of the input image information data. Further, in the area 123, this synthesizing ratio control information data is set up so as to mix and output 50% of the second synthesizing image information data and 50% of the input image information data. Further, in the area 124 this synthesizing ratio control information data is set up so as not to mix the synthesizing image information data but to output the input image information data only.

Based on such synthesizing ratio control information data, the synthesizing ratio control unit 152 controls the multipliers 153 through 155 by supplying the synthesizing ratios, and outputs the image which is obtained by mixing the first synthesizing image information data, the second synthesizing image information data, and the input image information data at a predetermined ratio.

Now, returning to FIG. 10, in step S47 when it is determined not to generate the synthesizing ratio control information data, the control unit 152 controls the processes in steps S48 and S49 so as to be skipped, and moves the process to step S51 of FIG. 11. In step S51 of FIG. 11, the synchronizing signal separation processing unit 11 separates the synchronizing signal from the supplied input image signal, and the separated synchronizing signal is supplied to the address generation counter 12. In step S52, based on the supplied synchronizing signal, the address generation counter 12 generates the address information data in which one screen is considered to be one period, and supplies it to the control unit 151, the first plane memory 18, the second plane memory 19, and the synthesizing ratio control unit 152.

In step S53, having acquired the synthesizing ratio control information data from the control unit 151, the synthesizing ratio control unit 152 specifies a pixel of attention based on the address information data. Based on the synthesizing ratio control information data, the synthesizing ratio control unit 152 determines, at the pixel of attention, whether or not to mix the first and second synthesizing image information data with the image information data contained in an input image signal. When it is determined to mix it with the first or second synthesizing image information data, the synthesizing ratio control unit 152 moves the process to step S54, and determines, at the pixel of attention, whether or not the synthesizing image (the character or graphics to be synthesized) exists, according to the first or second synthesizing image information data acquired from the first plane memory 18 or the second plane memory 19.

In step S54 when it is determined that the synthesizing image exists, the synthesizing ratio control unit 152 moves the process to step S55. Based on synthesizing ratio control information data, it supplies the synthesizing ratio to the multipliers 153 through 155, and controls the first or second synthesizing image information data so as to be synthesized with the input image information data. In other words, the synthesizing ratio control information data 152 supplies the multipliers 153 through 155 with the synthesizing ratio of the value based on the synthesizing ratio control information data. The multiplier 153 multiplies the first synthesizing image information data with the supplied synthesizing ratio, and the resulting product is outputted to the adder 156. The multiplier 154 multiplies the second synthesizing image information data with the supplied synthesizing ratio, and the resulting product is outputted to the adder 156. Then, the multiplier 155 multiplies the input image information data with the supplied synthesizing ratio, and the resulting product is outputted to the adder 156. Having controlled the multipliers 153 through 155, the synthesizing ratio control unit 152 moves the process to step S57.

In addition, in step S53 when it is determined, at the pixel of attention, not to mix the first or second synthesizing image information data with the image information data contained in the input image signal, the synthesizing ratio control unit 152 moves the process to step S56 and supplies the synthesizing ratio to the multipliers 153 through 155, so as not to synthesize the synthesizing image information data but to output the input image information data only, whereby respective image information data are multiplied by the synthesizing ratio. In other words, the synthesizing ratio control information data 152 supplies the multipliers 153 and 154 with the synthesizing ratio having the value of “0”, and supplies the multiplier 155 with the synthesizing ratio having a value of “1.” The multipliers 153 through 155 multiply the supplied synthesizing ratios with respective image information data, and outputs the resulting products to the adder 156. Therefore, in this case the adder 156 is supplied with a signal having the value of “0” from the multipliers 153 and 154 and supplied with the input image information data as it is from the multiplier 155. Upon completion of the process in step S56, the synthesizing ratio control unit 152 moves the process to step S57.

In step S54 when it is determined that the synthesizing image does not exist, the synthesizing ratio control unit 152 moves the process to step S56. As described above, in order not to synthesize the synthesizing image information data but to output the input image information data only, the synthesizing ratio is supplied to the multipliers 153 through 155 so that respective image information data are multiplied by the synthesizing ratios. Upon completion of the processing in step S56, the synthesizing ratio control unit 152 moves the process to step S57.

In step S57, being supplied with the respective image information data after being multiplied by the synthesizing ratio, the adder 156 synthesizes the respective image information data so as to be outputted to the outside of the image synthesizing apparatus 150 as the output image signal.

For example, the multiplier 153 multiplies first synthesizing image information data corresponding to the first synthesizing image 221 (as shown in FIG. 12B) with the synthesizing ratio supplied from the synthesizing ratio control unit 152. As shown in the image 241 of FIG. 13A, in the first synthesizing image 221 the multiplier 153 multiplies the image information data of a pixel located in the area 222 with the synthesizing ratio having a value of “0.5”, and multiplies the image information data of a pixel located in the area 223 and the area 224 with the synthesizing ratio having the value of “0.”

In this way, the multiplier 153 generates the first synthesizing image information data corresponding to the first synthesizing image 251 as shown in FIG. 13B. The first synthesizing image 251 is constituted by a area 252 containing a circular pattern of horizontal lines, a area 253 containing a doughnut pattern (concentric circles) of horizontal lines, and the other area 254.

The area 252 is a area corresponding to the area 222 of FIG. 12B. The solid black circle in the area 222 is multiplied by the synthesizing ratio so as to be a circular pattern of horizontal lines in the area 252. Therefore, the position and size of this circular pattern of horizontal lines are the same as those of the solid black circle in the area 222. The area 253 is a area corresponding to the area 223 of FIG. 12B. The solid black doughnut-like pattern (concentric circles) in the area 222 is eliminated by multiplying the synthesizing ratio having the value of “0”, so that the pattern does not exist in the area 253. The area 254 is a area corresponding to the area 224 of FIG. 12B. The multiplier 153 supplies the thus obtained first synthesizing image information data to the adder 156.

For example, the multiplier 154 multiplies the second synthesizing image information data corresponding to the second synthesizing image 231 as shown in FIG. 12C with the synthesizing ratio supplied from the synthesizing ratio control unit 152. As shown in the image 241 of FIG. 13A, the multiplier 154 multiplies the image information data of a pixel located in the area 232 in the second synthesizing image 231 with the synthesizing ratio having a value of “0.3”, multiplies the image information data of a pixel located in the area 223 with the synthesizing ratio having the value of “0.5”, and multiplies the image information data of a pixel located in the area 224 with the synthesizing ratio having the value of “0.”

In this way the multiplier 154 generates the second synthesizing image information data corresponding to the second synthesizing image 261 as shown in FIG. 13C. The second synthesizing image 261 is constituted by a area 262 containing a triangle of vertical lines, a area 263 containing a quadrangle of vertical lines, and the other area 264.

The area 262 is a area corresponding to the area 232 of FIG. 12C. The solid black triangle in the area 232 is multiplied by the synthesizing ratio so as to be the triangle of vertical lines in the area 262. Therefore, the position and size of this triangle of vertical lines are the same as those of the solid black triangle in the area 232. The area 263 is a area corresponding to the area 233 of FIG. 12C. The solid black quadrangle in the area 233 is multiplied by the synthesizing ratio so as to be the quadrangle of vertical lines in the area 263. Therefore, the position and size of this quadrangle of vertical lines are the same as those of the solid black quadrangle in the area 233. The area 264 is a area corresponding to the area 234 of FIG. 12C. The multiplier 154 supplies the thus obtained second synthesizing image information data to the adder 156.

Further, for example, the multiplier 155 multiplies the input image information data corresponding to the input image 211 as shown in FIG. 12A with the synthesizing ratio supplied from the synthesizing ratio control unit 152. As shown in the image 241 of FIG. 13A, with respect to the input image 211, the multiplier 155 multiplies the image information data of a pixel located in the area 242 of the image 241 with the synthesizing ratio having a value of “0.2”, multiplies the image information data of a pixel located in the area 243 of the image 241 with the synthesizing ratio of having the value of “0.5”, and multiplies the image information data of a pixel located in the area 244 of the image 241 with the synthesizing ratio having the value of “1.”

In this way, the multiplier 155 generates the input image information data corresponding to the input image 271 as shown in FIG. 14A. The input image 271 is constituted by a area 272 of a pattern hatched diagonally upward to the left in the figure, a area 273 of a pattern hatched diagonally upward to the left in the figure, and the other area 274 of a pattern hatched diagonally upward to the right in the figure.

The area 272 is a area corresponding to the area 242 of FIG. 13A. In this area (272) the input image 211 the pattern hatched diagonally upward to the right in the figure is multiplied by the synthesizing ratio so as to be a stripe pattern hatched diagonally upward to the left in the figure. The area 273 is a area corresponding to the area 243 of FIG. 13A. In this area (273) the input image 211 of the pattern hatched diagonally upward to the right in the figure is multiplied by the synthesizing ratio so as to be a stripe pattern hatched diagonally upward to the left in the figure. Further, the area 274 is a area corresponding to the area 244 of FIG. 13A. In this area (274), the input image 211 of the pattern hatched diagonally upward to the right in the figure has been multiplied by the synthesizing ratio having the value of “1”, so that the image does not change.

The multiplier 155 supplies the thus obtained input image information data to the adder 156. The adder 156 respectively acquires such image information data, adds and synthesizes them together so as to generate the output image information data corresponding to the output image 281 as shown in FIG. 14B.

The output image 281 is an image obtained by adding and synthesizing the first synthesizing image 251 of FIG. 13B, the second synthesizing image 261 of FIG. 13C, and the input image 271 of FIG. 14A, and is constituted by the area 282 through area 284. The area 282 is a area corresponding to the area 242 of FIG. 13A. The area 283 is a area corresponding to the area 243. The area 284 is a area corresponding to the area 244.

Therefore, the area 282 includes the circular pattern of horizontal lines which exists in the area 252 of FIG. 13B, the triangle of vertical lines which exists in the area 262 of FIG. 13C, and the pattern, of the area 272 in the input image 271 of FIG. 14A, hatched diagonally upward to the left in the figure. In other words, the image of the area 282 is an image which is a mixture of the images of the area 252, the area 262, and the area 272. At this stage, part where there are no patterns, such as a circle, a triangle, etc. in the area 252 and the area 262 is not mixed with the images of the area 252 and the area 262, so that the image of the area 282 is the image of the area 272 as it is.

The area 283 includes the quadrangle of vertical lines which exists in the area 263 of FIG. 13C and the pattern, of the area 274 in the input image 271 of FIG. 14A, hatched diagonally upward to the left in the figure. In other words, the image of the area 283 is an image which is a mixture of the images of the area 263 and the area 273. At this stage, part where the quadrangle of the area 263 does not exist is not mixed with the image of the area 263, so that the image of the area 283 is the image of the area 273 as it is.

In the area 284, the image of the pattern, of the area 274 in the input image 271 of FIG. 14A, hatched diagonally upward to the right in the figure is outputted as it is. As described above, the adder 156 synthesizes the input image information data, the first and second synthesis image information data, so as to be outputted to the outside of the image synthesizing apparatus 150 as the output image signal.

Now, returning to FIG. 11, in step S58 the synthesizing ratio control unit 152 determines whether or not all the pixels within a frame or the data for one screen have been processed. When it is determined that the pixels for one period of address information data have not been processed yet and all the pixels in the frame have not been processed, it moves the process to step S59. According to the address information data, it pays attention to the following pixel, and returns the process to step S53, and the subsequent processes are repeated.

In other words, each part of the image synthesizing apparatus 150 processes one frame of the image information data on a pixel-by-pixel basis by repeating the process of step S53 through step S59. In step S58 when it is determined that all the pixels in the frame have been processed, the synthesizing ratio control unit 152 moves the process to step S60.

In step S60 the control unit 151 determines whether or not to terminate the image synthesis process. When the image information data corresponding to the following frame is inputted as an input image signal and it is determined not to terminate the image synthesis process, the process is returned to step S41 of FIG. 10, and the subsequent processes are repeated.

In other words, by repeating the processes of step S41 through step S60, each part of the image synthesizing apparatus 150 performs the image synthesis process for every frame with respect to all the input image information data contained in the input image signal. Thus, the image synthesizing apparatus 150 generates, for every frame, the output image information data synthesized by mixing the first synthesizing image information data, the second synthesizing image information data, and the input image information data for every arbitrary area, so as to output it to the outside of the image synthesizing apparatus 150 as the output image signal. In other words, the image synthesizing apparatus 150 can switch the synthesizing images mixed with the input image for every arbitrary area. In this case, unlike a conventional apparatus, the control unit 151 does not create the synthesizing image information data, or performs the control process so that the created synthesizing image information data may be synthesized with the input image information data. It may only supply the synthesizing ratio control information data to the synthesizing ratio control unit 152 so as to easily switch the synthesizing images.

In step S60, for example, when the input of the input image signal is stopped and it is determined to terminate the image synthesis process, the control unit 151 moves the process to step S61, and carries out the termination process so as to terminate the image synthesis process.

In this way, each part of the image synthesizing apparatus 150 performs the image synthesis process, whereby the image synthesizing apparatus 150 can easily synthesize the plurality of image information data, with the circuit size and the manufacturing costs remaining reduced.

As described above, the image synthesizing apparatus to which the present invention is applied can easily synthesize the plurality of image information data by way of more various and complicated method, with the circuit size and the manufacturing costs remaining reduced.

Next, an example in which such an image synthesizing apparatus is used as part of an apparatus will be described. FIG. 15 is a block diagram showing an example of structure of a camcorder (Registered Trademark) to which the present invention is applied.

In FIG. 15, the camcorder 300 images a photographic subject, stores the acquired image information data (moving image or still image) in a recording medium, or displays an image corresponding to the image information data on a display, during which the camcorder 300 synthesizes the image information data obtained by imaging with other images as described above. A camera unit 310 of the camcorder 300 is controlled by a control unit 340 as will be described later, performs an imaging process, generates the image information data, and supplies the image information data to a DSP (Digital Signal Processor) 320.

In the camera unit 310, light from the photographic subject (not shown) is incident to a CCD (Charge Coupled Device) 312 through a lens unit 311 constituted by a lens, an aperture mechanism, etc., and the light is converted into electrical signals.

The image signal outputted by the CCD 312 is supplied to a pre-process circuit 313. The pre-process circuit 313 is constituted by a CDS (Correlated Double Sampling circuit) circuit, an AGC (Automatic Gain Control circuit) circuit, and an A/D (Analog/Digital) converter, etc., which are not shown. The pre-process circuit 313 removes a noise component from the inputted image signal in the CDS circuit, adjusts a gain of the image signal in the AGC circuit, then converts the image signal which is an analog signal into a digital signal in the A/D converter, and outputs the digital signal to the DSP 320 as image information data.

The camera unit 310 is provided with a timing generation circuit 314 which is controlled by a CPU (Central Processing Unit) 341 of the control unit 340 and generates a timing signal. The timing generation circuit 314 is controlled by the CPU 341 so as to supply the timing signal to a driver 315 which controls operation of the lens unit 311, a driver 316 which controls operation of the CCD 312, and the CCD 312, respectively.

Based on the supplied timing signal, the driver 315 controls the operation of the lens unit 311 so as to adjust its aperture, zoom lens, shutter, etc. Based on the supplied timing signal, the driver 316 supplies a control signal to the CCD 312. Based on the control signal supplied from the driver 316 and the timing signal supplied from the timing generation circuit 314, the CCD 312 carries out processes such as capture of the image signal etc.

The DSP 320 is supplied with the image information data from the pre-process circuit 313, and includes therein an adjustment processing unit 321 which performs a process with respect to adjustment of the image information data, a compression/decompression processing unit 322 which compresses or decompresses the image information data, an SDRAM controller 323 which controls input and output of an SDRAM (Synchronous Dynamic Random Access Memory) 331 holding the image information data, etc. The DSP 320 causes the SDRAM 331 to hold the acquired image information data, as needed, which is subjected to digital signal processing, and supplies the processed image information data to the control unit 340.

Based on the image information data, the adjustment processing unit 321 generates control signals, such as an AF (Auto Focus) control signal, an AE (Auto Exposure) control signal, an AWB (Auto White Balance) control signal, etc., so that the control signals are supplied to the control unit 340 through a bus 332. Further, the compression/decompression unit 322 compresses or decompresses the image information data by way of a predetermined compression/decompression method, during which the compression/decompression unit 322 causes the SDRAM 331 controlled by the SDRAM controller 323 to temporarily hold the image information data.

Being subjected to the digital signal processing in this way, the image information data is supplied through the bus 332 to the control unit 340. The control unit 340 is constituted by the CPU 341, a ROM 342, a RAM (Random Access Memory) 343, a clock circuit 345, etc., and controls each part of the camcorder 300. The CPU 341 controls each part or performs various types of processes according to a program stored in the ROM 342, or a program loaded into the RAM 343 from the outside of the camcorder 300 through the removable media 355 mounted at the drive 354 or an external I/F (Inter-Face) 357. The RAM 343 stores therein data required by the CPU 341 when implementing various types of processes, as needed. The RAM 343 temporarily stores therein the image information data etc. processed by each part.

Based on instructions information data from a user which are inputted through an input unit 356, the control information data supplied from the DSP 320, the information data acquired by performing various types of programs, or the like, the CPU 341 controls the timing generation circuit 314, and controls the operation of the lens unit 311 or the CCD 312. According to a request from each part, the clock circuit 345 provides the present date, the present day of the week, the present time as well as imaging date and time etc.

The CPU 341, the ROM 342, the RAM 343, and the clock circuit 345 are mutually connected through the bus 344. This bus 344 is also connected with the bus 332 to which the DSP 320 is connected. Further the bus 344 is connected with the image synthesis processing unit 351 which synthesizes the plurality of image information data.

Details of structure of the image synthesis processing unit 351 are basically similar to those of the image synthesizing apparatus 1 as shown in FIG. 1 or of the image synthesizing apparatus 150 as shown in FIG. 8, and operates similarly, so that the block diagram of FIG. 1 or FIG. 8 is applicable. In other words, the image synthesis processing unit 351 performs processes similar to those in the case of the image synthesizing apparatus 1 or the image synthesizing apparatus 150 as described above so that the plurality of image information data are synthesized. In this case, as will be described later, the image synthesis processing unit 351 is controlled by the CPU 341 through the bus 344 so as to perform the process. Therefore, unlike in the case of FIG. 1 and FIG. 8, as for the image synthesis processing unit 351, the input terminal 14 may only be connected with the bus 344, so that the ROM 15 and the drive 16 (removable media 17) may not necessarily be provided. Further, in the case of the image synthesis processing unit 351, the input image signal is adapted to be inputted through the bus 344 and the output image signal is adapted to be outputted to the bus 344.

The bus 344 is further connected with an LCD control unit 352 which controls operation of an LCD (Liquid Crystal Display) 353 and the information data outputted thereto and inputted therein; a drive 354 to be equipped with the removable media 355 including a magnetic recording medium (a flexible disk, a hard disk, a magnetic tape, etc.), an optical disc, a magneto-optical disc, a semiconductor memory, etc.; the input unit 356 which is subjected to operation by a user; and the external I/F 357 to which other apparatuses are connected.

The LCD control unit 352 includes therein a VRAM (Video Random Access Memory) which is not shown. For example, the LCD control unit 352 stores, in the built-in VRAM, the image information data acquired from the DSP 320, the image information data acquired from the CPU 341, the image information data held at the RAM 343, the image information data acquired from the image synthesis unit 351, the image information data stored in the removable media 355, the image information data acquired through the external I/F 357, or the like, so that the image corresponding to the image data stored in the VRAM is displayed on the LCD 353.

The drive 354 reads the computer program stored in the removable media 355 mounted at the drive 354, and supplies it to the CPU 341 which is caused to install it in the RAM 343 etc. Into the removable media 355 mounted at the drive 354, the drive 354 stores various types of information data, such as the image information data, supplied from respective parts of the camcorder 300, such as for example the DSP 320, the CPU 341, the RAM 343, the image synthesis processing unit 351, the input unit 356, the external I/F 357, etc.

The input unit 356 is constituted by various types of buttons, such as a shutter button and a menu button, a dial, a knob, a touch panel, etc. (none is shown). Being operated by the user, it receives various instructions from the user, and supplies the instruction information data to each part of the camcorder 300, such as for example the CPU 341.

The external I/F 357 is constituted by a connector in the shape in accordance with a predetermined standard, a driver for communication based on the standard, etc., and is connected to another apparatus in a predetermined method. Another apparatus connected to the external I/F 357 communicates with the camcorder 300 via the external I/F 357 so as to exchange the data or the program. In addition, the external I/F 357 has a predetermined communications antenna through which it may be connected with another apparatus by way of wireless communications via the antenna.

In the camcorder 300 as described above, the image synthesis processing unit 351 is controlled by the CPU 341 so as to acquire the image information data held in the RAM 343, the image information data supplied from the DSP 320, the image information data connected to the removable media 355 which is mounted at the drive 354, or the image information data supplied from another apparatus through the external I/F 357 via the bus 344, during which in the case of a compressed image information data, the image synthesis processing unit 351 supplies the image information data to the compression/decompression unit 322 of the DSP 320, causes the image information data to be decompressed, and then acquires it.

Having acquired the image information data, the image synthesis processing unit 351 inserts or mixes the synthesizing image corresponding to the synthesizing image information data supplied from the CPU 341 into an image corresponding to the image information data, for example, so that two image information data are synthesized in such a manner as described above.

Then the image synthesis processing unit 351 supplies the synthesized image information data, through the bus 344, to the CPU 341 or the DSP 320 which is caused to perform the image processing, causes the RAM 343 to hold it, supplies it to the LCD control unit 352 which is caused to display the image corresponding to image information data on the LCD 353, supplies it to the drive 354 and causes the removable media 355 mounted at the drive 354 to store it, or supplies it to another apparatus through the external I/F 357.

By providing the image synthesis processing unit 351 as described above and causing it to implement the image synthesis processing, the camcorder 300 can easily synthesize the image information data obtained by imaging or the image information data acquired from the outside with another image information data by way of various and complicated methods, and use the synthesized image information data, with the circuit size and the manufacturing costs remaining reduced.

In addition, for example, when a still image is recorded on a recording medium, the still image can be one frame of a moving image. When the still image is displayed on an LCD etc., the still image can be considered as a moving image in which images of the same frame follow one after another. Therefore, the present invention may similarly be applied to either the image information data of the moving image or the image information data of the still image.

Although in the above description the present invention has been exemplified by the camcorder to which the present invention is applied, the present invention can be applied to other apparatuses, for example, image processing apparatuses, such as a video camera, a digital still camera, a videocassette recorder, a television receiving and indicating apparatus, information processing apparatuses, such as a personal computer, a PDA (Personal Digital Assistants), etc., and communication apparatuses, such as a portable telephone, and the like. In addition, the present invention may be more effectively applied to a small apparatus, such as a mobile computing device, which has limits on its circuit size and manufacturing costs.

In the above description, the address generation counter 12 has been described as generating the address information data based on the synchronizing signal which is separated from the input image signal by the synchronizing signal separation processing unit 11. However, the present invention is not limited thereto, and the address information data may be generated based on any type of data. For example, the address generation counter 12 may include therein a clock signal generating circuit, so that the address information data may be generated based on a clock signal generated by the clock signal generating circuit. Further, the address generation counter 12 may generate the address information data based on a clock signal supplied from the outside of image synthesis process apparatus.

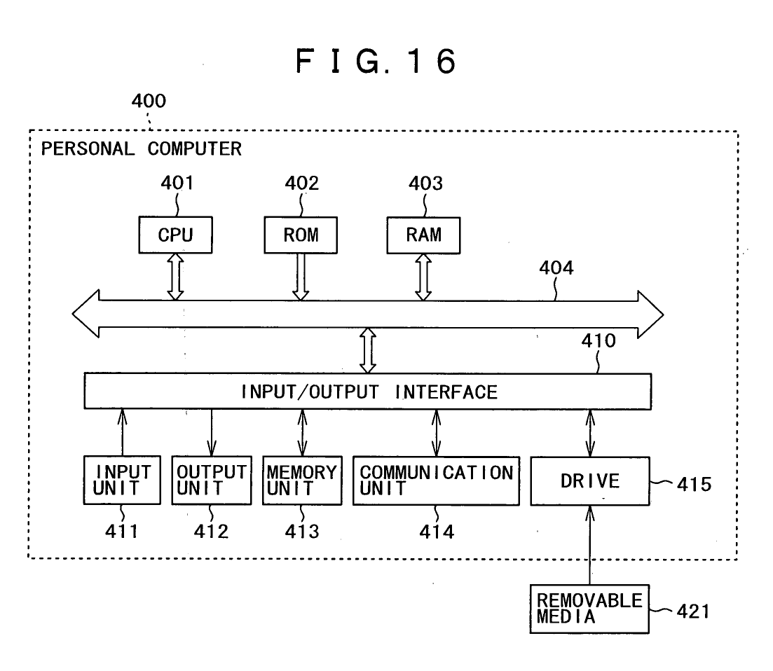

A series of processes as described above can be performed by means of hardware or by way of software. When they are performed by way of software, the present invention may be embodied by a personal computer as shown in FIG. 16, for example. In FIG. 16, a CPU 401 of a personal computer 400 performs various types of processes according to a program stored in a ROM 402 or a program loaded from a memory unit 413 into a RAM 403. The RAM 403 suitably stores therein the data necessary for the CPU 401 to perform various types of processes.

The CPU 401, the ROM 402, and RAM 403 are mutually connected through the bus 404, with which an input/output interface 410 is also connected. The input/output interface 410 is connected with an input unit 411 which may be a keyboard, a mouse, etc., an output unit 412 which may be a speaker etc. as well as a display including a CRT (Cathode Ray tube), an LCD, etc., a memory unit 413 which may be a hard disk etc., and a communication unit 414 which may be a modem etc. The communication unit 414 performs a communications process through a network including the Internet.

The input/output interface 410 is also connected with a drive 415 where a removable media 421 is suitably mounted as needed which may be a magnetic disk, an optical disc, a magneto-optical disc, a semiconductor memory, or the like. A computer program read out thereof is installed in the memory unit 413 as needed. When a series of processes are performed by way of software, the program which constitutes the software is installed over the network or from the recording medium.

As shown in FIG. 16, the recording medium may not only be the removable media 421 having recorded therein a program which includes a magnetic disk (including a floppy disk), an optical disc (including a CD-ROM (Compact Disk-Read Only Memory) and a DVD (Digital Versatile Disk)), a magneto-optical disc (including an MD (Mini-Disk), a semiconductor memory, etc., and is delivered to a user for providing the program independently of the main part of the apparatus, but also be the ROM 402 or a hard disk contained in the memory unit 413, on which the program is recorded and which is assembled into the main apparatus beforehand so as to be provided for the user.

In the specification, the steps which describes the program to be recorded on the recording medium may include not only the processes serially performed in accordance with the described order but also the processes performed in parallel or individually, so that the steps may not necessarily be processed serially.

Further in the specification, a system means the whole apparatus comprising a plurality of apparatus.

What is claimed is:

1. An image processing apparatus in which an input image information data which is an image information data contained in an input image signal is synthesized with an synthesizing image information data which is an image information data different from the input image information data, the image processing apparatus comprising:
synthesizing image information data holding means for holding a plurality of the synthesizing image information data;
synthesis control means for controlling synthesis of the input image information data and the plurality of the input synthesizing image information data which are held in the synthesizing image information data holding means, for every arbitrary area of the input image corresponding to the input image information data; and
image information data synthesis means for synthesizing the input image information data and the synthesizing image information data according to the control by means of the synthesis control means.

2. The image processing apparatus as recited in claim 1, wherein:
the synthesizing image holding means holds the synthesizing image information data as a data on a pixel-by-pixel basis.

3. The image processing apparatus as recited in claim 1, wherein:
the synthesizing image holding means holds information data obtained by arranging the synthesizing image information data in a table.

4. The image processing apparatus as recited in claim 1, wherein:
the synthesis control means includes control information data holding means for holding control information data about control of synthesis of the synthesizing image information data and the input image information data, so as to control the synthesis of the synthesizing image information data and the input image information data according to the control information data held in the control information data holding means.

5. The image processing apparatus as recited in claim 4, wherein:
the control information data is an information data for specifying, in the arbitrary area, the synthesizing image information data corresponding to a synthesizing image to be superimposed on the input image by selecting it from the plurality of synthesizing image information data held in the synthesizing image information data holding means, based on the control information data, the synthesis control means determines whether or not each of the plurality of synthesizing image information data held in the synthesizing image information data holding means is synthesized with the input image information data, such that the synthesizing image information data which has been determined to be synthesized is controlled to be synthesized with the input image information data, and based on the control by means of the synthesis control means, the image information data synthesis means synthesizes the input image information data and the synthesizing image information data so as to superimpose the input image on the synthesizing image in the arbitrary area.

6. The image processing apparatus as recited in claim 4, wherein:
the control information data is an information data for specifying the synthesizing ratio of each image information data in the arbitrary area, when mixing the input image with the synthesizing image corresponding to the plurality of synthesizing image information data held in the synthesizing image information data holding means, based on the control information data, the synthesis control means controls the plurality of synthesizing image information data held at the synthesizing image information data holding means so as to be synthesized with the input image information data at the specified synthesizing ratio, and based on the control by means of the synthesis control means, the image information data synthesis means synthesizes the input image information data and the synthesizing image information data so as to mix the input image and the synthesizing image at the specified synthesizing ratio in the arbitrary area.

7. The image processing apparatus as recited in claim 4, wherein:
the synthesis control means further includes, in the arbitrary area, graphics determination means for determining whether or not graphics exist in the synthesizing image corresponding to the synthesizing image information data synthesized with the input image information data, and when it is determined that there are not graphics by way of the determination through the graphics determination means, the synthesis control means controls the synthesizing image information data so as not to be synthesized with the input image information data.

8. The image processing apparatus as recited in claim 4, wherein:
an amount of data of the control information data is smaller than an amount of data of the synthesizing image information data held in the synthesizing image information data holding means.

9. The image processing apparatus as recited in claim 4, wherein:
the control information data is information data on a pixel-by-pixel basis.

10. The image processing apparatus as recited in claim 4, wherein:
the control information data is an information data obtained by arranging transition points where control changes, in a table.

11. The image processing apparatus as recited in claim 1, further including:
address information data generation means for generating the address information data which indicates a location in a screen for the input image, wherein
based on the address information data generated by the address information data generation means, the synthesis control means controls the synthesis of the input image information data and the plurality of synthesizing image information data held in the synthesizing image information data holding means such that synthesis locations of the synthesizing image information data and the input image information data may be positioned properly.

12. The image processing apparatus as recited in claim 11, further including:
synchronizing signal separation means for separating a synchronizing signal added to the input image information data, wherein
the address information data generation means generates the address information data, based on the synchronizing signal separated from the input image information data by the synchronizing signal separation means.

13. An image processing method for an image processing apparatus in which an synthesizing image information data which is an image information data and different from an input image information data is synthesized with the input image information data which is an image information data contained in an input image signal, the image processing method including the steps of:
an synthesizing image information data hold control step of controlling hold of a plurality of the synthesizing image information data;
a synthesis control step of controlling synthesis of the input image information data and the plurality of synthesizing image information data which are controlled and held by way of a process of the synthesizing image information data hold control step, for every of an input image corresponding to the input image information data; and
an image information data synthesis step of synthesizing the input image information data and the synthesizing image information data, according to the control by way of the process of the synthesis control step.

14. The image processing method as recited in claim 13, wherein:
the synthesizing image hold control step controls and holds the synthesizing image information data as a data on a pixel-by-pixel basis.

15. The image processing method as recited in claim 13, wherein:
the synthesizing image hold control step controls and holds information data obtained by arranging the synthesizing image information data in a table.

16. The image processing method as recited in claim 13, wherein:
the synthesis control step includes a control information data hold control step of controlling hold of the control information data about the control of the synthesis of the synthesizing image information data and the input image information data, and
based on the control information data which is controlled and held by way of the process of the control information data hold control step, the synthesis control step controls the synthesis of the synthesizing image information data and the input image information data.

17. The image processing method as recited in claim 16, wherein:
the synthesis control step determines, in the arbitrary area, whether each of the plurality of synthesizing image information data which are controlled and held by way of the process of the synthesizing image information data hold control step is synthesized with the input image information data or not, according to the control information data for specifying the synthesizing image information data corresponding to the synthesizing image which is superimposed on the input image, by selecting it from the plurality of synthesizing image information data which are controlled and held by way of the process of the synthesizing image information data hold control step, the synthesizing image information data which has been determined to be synthesized is controlled so as to be synthesized with the input image information data, and
based on the control byway of the process of the synthesis control step, the image information data synthesis step synthesizes the input image information data and the synthesizing image information data so as to superimpose the input image on the synthesizing image in the arbitrary area.

18. The image processing method as recited in claim 16, wherein:
the synthesis control step controls, in the arbitrary area, the plurality of synthesizing image information data which are controlled and held by way of the process of the synthesizing image information data hold control step so as to be synthesized with the input image information data at the specified synthesizing ratio, according to the control information data for specifying the synthesizing ratio of each image information data when mixing, with the input image, the synthesizing image corresponding to the plurality of synthesizing image information data which are controlled and held by way of the process of the synthesizing image information data hold control step, and
based on the control by way of the process of the synthesis control step, the image information data synthesis step synthesizes the input image information data and the synthesizing image information data so as to mix the input image and the synthesizing image at the specified synthesizing ratio in the arbitrary area.

19. The image processing method as recited in claim 16, wherein:
the process of the synthesis control step further includes a graphics determination step of determining whether or not graphics exist in the synthesizing image corresponding to the synthesizing image information data which is synthesized with the input image information data in the arbitrary area, and
when it is determined that there are not the graphics through the determination by way of the process of the graphics determination step, the process of the synthesis control step controls the synthesizing image information data so as not to be synthesized with the input image information data.

20. The image processing method as recited in claim 16, wherein:
the amount of data of the control information data is smaller than the amount of data of the synthesizing image information data which is controlled and held by way of the process of the synthesizing image information data hold control step.

21. The image processing method as recited in claim 16, wherein:
the control information data is information data on a pixel-by-pixel basis.

22. The image processing method as recited in claim 16, wherein:
the control information data is an information data obtained by arranging transition points where the control changes, in a table.

23. The image processing method as recited in claim 13, further including:
an address information data generation step of generating the address information data which indicates a location in a screen for the input image, wherein
based on the address information data generated by way of the process of the address information data generation step, the synthesis control step controls the synthesis of the input image information data and the plurality of synthesizing image information data which are controlled and held by way of the process of the synthesizing image information data hold control step, so that the synthesis locations of the synthesizing image information data and the input image information data may be positioned properly.

24. The image processing method as recited in claim 23, further including:
a synchronizing signal separation step of separating a synchronizing signal added to the input image information data, wherein
the address information data generation step generates the address information data, based on the synchronizing signal separated from the input image information data by way of the process of the synchronizing signal separation step.

25. An imaging apparatus including:
an imaging means for imaging a photographic subject and capturing an taken image information data which is an acquired image information data;
an synthesizing image information data holding means for holding a plurality of synthesizing image information data which are synthesized with the taken image information data captured by the imaging means;
a synthesis control means for controlling synthesis of the taken image information data and the plurality of synthesizing image information data which are held in the synthesizing image information data holding means, for every arbitrary area of the taken image corresponding to the taken image information data; and
an image information data synthesis means for synthesizing the taken image information data and the synthesizing image information data according to control by means of the synthesis control means.
